(19) United States
(12) Patent Application Publication
(10) Pub. No.: US 2015/0156769 A1
(43) Pub. Date: Jun. 4, 2015

(54) METHOD AND DEVICE FOR SENDING DATA

(71) Applicant: Huawei Technologies Co., Ltd., Shenzhen (CN)

(72) Inventors: David MAZZARESE, Shenzhen (CN); Mingyu ZHOU, Shenzhen (CN); Bo LIN, Shenzhen (CN); Hao BI, Shenzhen (CN); Yan WANG, Shenzhen (CN)

(21) Appl. No.: 14/620,962

(22) Filed: Feb. 12, 2015

Related U.S. Application Data
(63) Continuation of application No. PCT/CN2012/080311, filed on Aug. 17, 2012.

(51) Int. Cl. H04W 72/04

(52) U.S. Cl. CPC H04W 72/0413; H04W 72/042; H04W 72/0446

(57) ABSTRACT

The embodiments of the present disclosure provide a method and device for sending data. A second network equipment receives user data sent by a first network equipment through a first interface. The second network equipment receives control signaling sent by the first network equipment through a second interface, where the second interface is an air interface. The second network equipment sends the user data to a user equipment according to the control signaling. The first network equipment can send the control signaling to the UE and the second network equipment through the air interface, and does not send the control signaling and data signaling to the second network equipment through the same X2 interface.

### CROSS-REFERENCE TO RELATED APPLICATIONS

This application is a continuation of International Patent Application No. PCT/CN2012/080311, filed on Aug. 17, 2012, which is hereby incorporated by reference in its entirety.

### TECHNICAL FIELD

The prevent disclosure relates to the field of wireless communication and, in particular, to a method and device for sending data.

### BACKGROUND

In the prior art, one user equipment (UE) generally communicates with only one network equipment. Specifically, the UE detects control signaling sent by the network equipment and receives downlink data signals sent by the network equipment according to the detected control signaling.

As shown in FIG. 1, in a long term evolution (LTE) system, the time length of one transmission time interval (TTI) is 1 ms. One TTI comprises 14 symbols; and a network equipment sends control signaling for scheduling resource of downlink data signals to a UE on the first i symbols of the nth TTI and sends the downlink data signals to the UE on other symbols of the TTI, wherein i is equal to 2 as shown in FIG. 1, and i can also be another value. In this way, after determining a downlink scheduling scheme for the UE, the network equipment can quickly send the downlink data signals to the UE, so that the scheduling scheme can timely adapt to quick changes of a channel. The downlink scheduling scheme, for example, can comprise frequency resources distributed to the UE by the network equipment, a modulation and coding scheme (MCS) and the like.

With the development of the communication technology, a communication scene appears. In the communication scene, the network equipment for sending control signaling to a UE is different from the network equipment for sending downlink data signals to the UE. In this way, complex scheduling functions can be unified to one network equipment for sending the control signaling to the UE, and the network equipment for sending the downlink data signals to the UE can only have the function of sending the downlink data signals rather than the function of sending the control signaling to the UE, so that quick decision of scheduling, simple coordination between network equipments and simple design between network equipments are facilitated.

Moreover, a coordinated multiple point transmission/reception (CoMP) technology is provided. Namely, multiple network equipments can serve the UE in a coordinated mode, so that the system performance is enhanced. In order to avoid the increase of complexity caused by the situation that the UE detects the control signaling sent by multiple network equipments, each UE fixedly detects the control signaling sent by one network equipment and receives the downlink data signals sent by the network equipment and other network equipments in a coordinated mode according to the detected control signaling, wherein the coordinated mode is not limited and can be dynamic point selection (DPS) or joint transmission (JT). The DPS means dynamically selecting one of the multiple network equipments to send downlink data signals to the UE; and the JT means that multiple network equipments send downlink data signals to the UE in a joint mode.

In the prior art, the connection between different network equipments is named as backhaul, generally, which is a wired interface. For example, in the LTE system, the different network equipments are connected through an X2 interface and exchange information through the X2 interface. The X2 interface has the defect that the information exchange has a great delay which generally reaches more than 10 ms. In this way, after a first network equipment determines the scheduling scheme of a certain UE, a second network equipment designated to send downlink data signals to the UE cannot receive the control signaling and acquire the scheduling scheme until a long time passes, and the second network equipment cannot send the downlink data signals to the UE until the control signaling is received, so that the information exchange delay between the network equipments in the prior art is longer. Moreover, timely scheduling cannot be realized according to the changes of a channel in the prior art, and the efficiency of a system is lower.

### SUMMARY

In view of this, the embodiments of the present disclosure provides a method and a device for sending data, so as to solve the problem of longer information exchange delay in the prior art.

At the first aspect, a method for sending data is provided. The method comprises: receiving, by a second network equipment, user data sent by a first network equipment through a first interface;

receiving, by the second network equipment, control signaling sent by the first network equipment through a second interface, wherein the second interface is an air interface; and

sending, by the second network equipment, the user data to a user equipment according to the control signaling.

In the first probable implementation of the first aspect, the sending, by the second network equipment the user data to a user equipment, comprising:

sending, by the second network equipment, the user data to the user equipment through the second interface.

With reference to the first aspect or the first probable implementation of the first aspect, in the second probable implementation,

the receiving, by a second network equipment, user data sent by a first network equipment, comprising: receiving, by the second network equipment, the user data sent by the first network equipment at the (n−M)^{th} transmission time interval (TTI), wherein M is a positive integer more than or equal to 1, and n is an integer;

the receiving, by the second network equipment, control signaling sent by the first network equipment, comprising: receiving, by the second network equipment, the control signaling at the nth TTI.

With reference to the second probable implementation, in the third probable implementation, the first interface is an X2 interface, and M is more than 10.

With reference to the first aspect or any one of the probable implementations of the first aspect, in the fourth probable implementation,

before the receiving, by the second network equipment, control signaling sent by the first network equipment, the method further comprises: receiving interval information of a first time period and a second time period sent by the first network equipment; the receiving, by the second network equipment, control signaling, comprising: receiving, by the second network equipment, the control signaling sent by the first network equipment through the second interface at the first time period; and the sending, by the second network equipment, the user data to a user equipment, comprising: determining the second time period according to the interval information and the first time period; and sending the user data to the user equipment according to the control signaling at the second time period; or,

before the receiving, by the second network equipment, control signaling sent by the first network equipment, the method further comprises: receiving information of a second time period sent by the first network equipment; the receiving, by the second network equipment, control signaling, comprising: receiving, by the second network equipment, the control signaling sent by the first network equipment through the second interface at the first time period; and the sending, by the second network equipment, the user data to a user equipment, comprising: determining the second time period according to the information of the second time period; and sending the user data to the user equipment according to the control signaling at the second time period.

With reference to the first aspect or any one of the probable implementations of the first aspect, in the fifth probable implementation, the sending, by the second network equipment, the user data to a user equipment according to the control signaling, comprising:

after the receiving, by the second network equipment, the control signaling, determining the user data corresponding to user equipment information according to the user equipment information in the control signaling, scheduling the user data corresponding to the user equipment information acquired from the first network equipment according to the control signaling, generating data signals by using the user data corresponding to the user equipment information, and sending the data signals to the user equipment.

With reference to the first aspect or any one of the probable implementations of the first aspect, in the sixth probable implementation, before the receiving, by a second network equipment, user data sent by a first network equipment through a first interface, the method further comprises:

sending, by the second network equipment, capability confirming information to the first network equipment, wherein the capability confirming information is used for indicating that the second network equipment supports receiving the control signaling from the second interface.

With reference to the first aspect or any one of the probable implementations of the first aspect, in the seventh probable implementation, before the receiving, by a second network equipment, user data sent by a first network equipment through a first interface, the method further comprises:

receiving, by the second network equipment, reference signal (RS) sent from the first network equipment to the second network equipment, determining channel quality between the first network equipment and the second network equipment according to the RS, and informing the first network equipment of the channel quality; or

sending, by the second network equipment, RS to the first network equipment, so that the first network equipment determines channel quality between the first network equipment and the second network equipment according to the RS.

With reference to the first aspect or any one of the probable implementations of the first aspect, in the eighth probable implementation, before the receiving, by the second network equipment, control signaling through a second interface, the method further comprises:

acquiring, by the second network equipment, user equipment information sent by the first network equipment;

the receiving, by the second network equipment, control signaling through a second interface, comprising: detecting and receiving, by the second network equipment, the control signaling according to the user equipment information.

With reference to the first aspect or any one of the probable implementations of the first aspect, in the ninth probable implementation, before the receiving, by the second network equipment, control signaling through a second interface, the method further comprises:

receiving a transmission time interval (TTI) set sent by the first network equipment;

the receiving, by the second network equipment, control signaling through a second interface, comprising: detecting and receiving, by the second network equipment, the control signaling at a TTI included in the TTI set.

With reference to the first aspect or any one of the probable implementations of the first aspect, in the tenth probable implementation, the control signaling contains processing indicating information, and the processing indicating information is used for indicating whether the second network equipment sends the user data acquired from the first network equipment to the user equipment according to the control signaling;

the sending, by the second network equipment, the user data to a user equipment according to the control signaling, comprising:

if the processing indicating information indicates that the user data acquired from the first network equipment is sent according to the control signaling, sending, by the second network equipment, the user data to the user equipment according to the control signaling.

With reference to the tenth probable implementation of the first aspect, in the eleventh probable implementation, the processing indicating information is an identity corresponding to the second network equipment.

With reference to the first aspect or any one of the probable implementations of the first aspect, in the twelfth probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the second aspect, a method for sending data is provided. The method comprises:

sending, by a first network equipment, user data to a second network equipment through a first interface; and

sending, by the first network equipment, control signaling through a second interface, so that the second network equipment sends the user data to a user equipment according to the control signaling, wherein the second interface is an air interface.

In the first probable implementation of the second aspect,

the sending, by a first network equipment. user data of a user equipment to a second network equipment, comprising: sending, by the first network equipment, the user data to the second network equipment at the (n−M)th transmission time interval (TTI), wherein M is a positive integer more than or equal to 1, and n is an integer;

the sending, by the first network equipment, control signaling, comprising: sending, by the first network equipment, the control signaling at the nth TTI.

With reference to the first probable implementation of the second aspect, in the second probable implementation, the first interface is an X2 interface, and M is more than 10.

With reference to the second aspect or the first probable implementation of the second aspect, in the third probable implementation, before the sending, by the first network equipment, control signaling through a second interface, the method further comprises: sending, by the first network equipment, interval information of a first time period and a second time period to the user equipment, and sending the interval information of the first time period and the second time period to the second network equipment, wherein the first time period is the one when the first network equipment sends the control signaling, and the second time period is the one when the second network equipment sends the user data; or

before the sending, by the first network equipment, control signaling through a second interface, the method further comprises: sending, by the first network equipment, information of a second time period to the user equipment, and sending the information of the second time period to the second network equipment, wherein the second time period is the one when the second network equipment sends the user data.

With reference to the second aspect or any one of the probable implementations of the second aspect, in the fourth probable implementation, before the sending, by a first network equipment, user data of a user equipment to a second network equipment, the method further comprises:

receiving capability confirming information sent from the second network equipment to the first network equipment, wherein the capability confirming information is used for indicating that the second network equipment supports receiving the control signaling from the second interface.

With reference to the second aspect or any one of the probable implementations of the second aspect, in the fifth probable implementation, before the sending, by a first network equipment, user data of a user equipment to a second network equipment, the method further comprises:

according to channel quality between the first network equipment and the second network equipment, judging, by the first network equipment, whether the channel quality can satisfy the condition that the second network equipment accurately receives the control signaling;

the sending, by a first network equipment, user data of a user equipment to a second network equipment, comprising: if the first network equipment determines that the channel quality can satisfy the condition that the second network equipment accurately receives the control signaling, sending the user data of the user equipment to the second network equipment through the first interface.

With reference to the fifth probable implementation of the second aspect, in the sixth probable implementation, before the judging whether the channel quality can satisfy the condition that the second network equipment accurately receives the control signaling, the method further comprises:

sending, by the first network equipment, reference signal (RS) to the second network equipment; and receiving, by the first network equipment, the channel quality informed by the second network equipment, wherein the channel quality is determined by the second network equipment according to the RS; or

receiving RS sent from the second network equipment to the first network equipment; and determining, by the first network equipment, the channel quality between the first network equipment and the second network equipment according to the RS.

With reference to the second aspect or any one of the probable implementations of the second aspect, in the seventh probable implementation, before the sending, by the first network equipment, control signaling through a second interface, the method further comprises:

sending, by the first network equipment, user equipment information to the second network equipment, so that the second network equipment detects the control signaling according to the user equipment information.

With reference to the second aspect or any one of the probable implementations of the second aspect, in the eighth probable implementation, before the sending, by the first network equipment, control signaling through a second interface, the method further comprises: sending, by the first network equipment, mode configuration signaling to the user equipment, wherein the mode configuration signaling is used for indicating that the user equipment receives the control signaling and the user data at the first time period and the second time period; or,

in the sending, by the first network equipment, control signaling through a second interface, the control signaling comprises mode configuration signaling sent from the first network equipment to the user equipment, and the mode configuration signaling is used for indicating that the user equipment receives the control signaling and the user data at the first time period and the second time period,

wherein, the first time period is the one when the user equipment and the second network equipment receive the control signaling, and the second time period is the one when the user equipment receives the user data from the second network equipment.

With reference to the second aspect or any one of the probable implementations of the second aspect, in the ninth probable implementation, the control signaling comprises processing indicating information, and the processing indicating information is used for indicating that the user data acquired from the first network equipment is sent to the user equipment according to the control signaling.

With reference to the second aspect or any one of the probable implementations of the second aspect, in the tenth probable implementation, before the sending, by the first network equipment, control signaling through a second interface, the method further comprises:

determining, by the first network equipment, a transmission time interval (TTI) set, and sending information of the TTI set, so that the second network equipment and the user equipment receive the control signaling at a TTI included in the TTI set.

With reference to the tenth probable implementation of the second aspect, in the eleventh probable implementation, the sending information of the TTI set, comprising:

sending, by the first network equipment, the information of the TTI set in a bitmap mode.

With reference to the tenth probable implementation or the eleventh probable implementation of the second aspect, in the eleventh probable implementation, the sending information of the TTI set, comprising:

sending, by the first network equipment, the information of the TTI set through the second interface.

With reference to the second aspect or any one of the probable implementations of the second aspect, in the twelfth probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the third aspect, a method for receiving data is provided. The method comprises:

at a first time period, receiving, by a user equipment, control signaling sent by a first network equipment;

at a second time period, according to the control signaling, receiving, by the user equipment, user data sent by a second network equipment according to the control signaling, wherein the first time period and the second time period are discontinuous.

In the first probable implementation of the third aspect,

the first time period and the second time period are in the same transmission time interval (TTI), the first time period and the second time period are spaced by N_sym symbols, and N_sym is more than or equal to 1 and less than or equal to 12; or

the first time period and the second time period are in different TTIs.

With reference to the third aspect or the first probable implementation of the third aspect, in the second probable implementation, if the first time period and the second time period are in different TTIs, the first time period is in a control domain of a first TTI, and the second time period is in a data domain of a second TTI.

With reference to the third aspect or any one of the probable implementations of the third aspect, in the third probable implementation, before the receiving, by a user equipment, control signaling sent by a first network equipment, the method further comprises: receiving interval information of the first time period and the second time period sent by the first network equipment, and determining the second time period according to the interval information and the first time period; or

before the receiving, by a user equipment, control signaling sent by a first network equipment, the method further comprises: receiving information of the second time period sent by the first network equipment, and determining the second time period according to the information of the second time period.

With reference to the third aspect or any one of the probable implementations of the third aspect, in the fourth probable implementation, before the receiving, by the user equipment, user data sent by a second network equipment according to the control signaling, the method further comprises: receiving mode configuration signaling sent from the first network equipment to the user equipment, wherein the mode configuration signaling is used for indicating that the user equipment receives the control signaling and the user data at the first time period and the second time period; or,

wherein the control signaling comprises mode configuration signaling, and the mode configuration signaling is used for indicating that the user equipment receives the control signaling and the user data at the first time period and the second time period.

With reference to the third aspect or any one of the probable implementations of the third aspect, in the fifth probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

In the fourth aspect, a network equipment is provided. The network equipment is a second network equipment, and comprises:

a first interface and a second interface, wherein the second interface is an air interface;

a receiving module, used for receiving user data sent by a first network equipment through the first interface and receiving control signaling sent by the first network equipment through the second interface;

a data processing module, used for acquiring the control signaling received by the receiving module and instructing a sending module to send the user data received by the receiving module; and

the sending module, used for sending the user data to a user equipment.

In the first probable implementation of the fourth aspect, the sending module is used for sending the user data to the user equipment through the second interface.

With reference to the fourth aspect or the first probable implementation of the fourth aspect, in the second probable implementation, the receiving module is used for receiving the user data sent by the second network equipment at the (n−M)th transmission time interval (TTI) and receiving the control signaling at the nth TTI, wherein M is a positive integer more than or equal to 1, and n is an integer.

With reference to the second probable implementation of the fourth aspect, in the third probable implementation, the first interface is an X2 interface, and M is more than 10.

With reference to the fourth aspect or any one of the probable implementations of the fourth aspect, in the fourth probable implementation, the receiving module is further used for receiving interval information of a first time period and a second time period sent by the first network equipment before receiving the control signaling sent by the first network equipment; and the data processing module is used for determining the second time period according to the interval information received by the receiving module and the first time period, and instructing the sending module to send the user data according to the control signaling at the second time period, wherein the first time period is the one when the second network equipment receives the control signaling; or

the receiving module is also used for receiving information of the second time period sent by the first network equipment before receiving the control signaling sent by the first network equipment; and the data processing module is used for determining the second time period according to the information of the second time period received by the receiving module and instructing the sending module to send the user data according to the control signaling at the second time period, wherein the first time period is the one when the second network equipment receives the control signaling.

With reference to the fourth aspect or any one of the probable implementations of the fourth aspect, in the fifth probable implementation, the data processing module is further used for instructing the sending module to send capability confirming information before the receiving module receives the user data, wherein the capability confirming information is used for indicating that the second network equipment supports receiving the control signaling from the second interface;

the sending module is further used for sending the capability confirming information to the first network equipment.

With reference to the fourth aspect or any one of the probable implementations of the fourth aspect, in the sixth probable implementation, the network equipment further comprises a measuring module; the receiving module is further used for receiving reference signal (RS) sent from the first network equipment to the second network equipment before receiving the user data sent by the first network equipment through the first interface; the measuring module is used for determining channel quality between the first network equipment and the second network equipment according to the RS received by the receiving module; and the sending module is further used for informing the first network equipment of the channel quality determined by the measuring module; or

the data processing module is further used for instructing the sending module to send RS before the user data is received; and the sending module is further used for sending the RS to the second network equipment, so that the first network equipment determines channel quality between the first network equipment and the second network equipment according to the RS.

With reference to the fourth aspect or any one of the probable implementations of the fourth aspect, in the seventh probable implementation, the receiving module is further used for receiving user equipment information sent by the first network equipment before receiving the control signaling;

the receiving module is used for receiving the control signaling in the following mode: detecting and receiving the control signaling according to the user equipment information.

With reference to the fourth aspect or any one of the probable implementations of the fourth aspect, in the eighth probable implementation, the receiving module is further used for receiving a transmission time interval (TTI) set determined by the first network equipment before receiving the control signaling;

the receiving module is used for receiving the control signaling in the following mode: detecting and receiving the control signaling at a TTI included in the TTI set.

With reference to the fourth aspect or any one of the probable implementations of the fourth aspect, in the ninth probable implementation, the data processing module is used for instructing the sending module to send the user data received by the receiving module in the following mode:

if processing indicating information indicates that the user data acquired from the first network equipment is scheduled according to the control signaling, instructing the sending module to send the user data according to the control signaling, wherein the control signaling comprises the processing indicating information for indicating that the user data acquired from the first network equipment is sent to the user equipment according to the control signaling.

With reference to the fourth aspect or any one of the probable implementations of the fourth aspect, in the tenth probable implementation, the network equipment also comprises:

a storing module, used for storing the user data sent by the first network equipment and received by the receiving module through the first interface;

the data processing module, used for determining the user data corresponding to user equipment information from the storing module according to the user equipment information in the control signaling after the control signaling is received, and sending the user data corresponding to the user equipment information according to the control signaling.

With reference to the fourth aspect or any one of the probable implementations of the fourth aspect, in the eleventh probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the fifth aspect, a network equipment is provided. The network equipment is a first network equipment, and comprises:

a first interface and a second interface, wherein the second interface is an air interface;

a determining module, used for instructing a sending module to send user data of a user equipment to a second network equipment through the first interface, and instructing the sending module to send control signaling through the second interface;

the sending module, used for sending the user data of the user equipment to the second network equipment through the first interface, and sending the control signaling through the second interface, so that the second network equipment sends the user data to the user equipment according to the control signaling, wherein the second interface is the air interface.

In the first probable implementation of the fifth aspect, the sending module is used for sending the user data to the second network equipment at the (n−M)th transmission time interval (TTI), and sending the control signaling at the nth TTI, and wherein M is a positive integer more than or equal to 1, and n is an integer.

With reference to the first probable implementation of the fifth aspect, in the second probable implementation, the first interface is an X2 interface, and M is more than 10.

With reference to the fifth aspect or any one of the probable implementations of the fifth aspect, in the third probable implementation, before sending the control signaling through the second interface, the sending module is further used for sending interval information of a first time period and a second time period to the user equipment, and sending the interval information of the first time period and the second time period to the second network equipment, wherein the first time period is the one when the first network equipment sends the control signaling, and the second time period is the one when the second network equipment sends the user data; or

before sending the control signaling through the second interface, the sending module is further used for sending information of second time period to the user equipment, and sending the information of the second time period to the second network equipment, wherein the first time period is the one when the first network equipment sends the control signaling, and the second time period is the one when the second network equipment sends the user data.

With reference to the fifth aspect or any one of the probable implementations of the fifth aspect, in the fourth probable implementation, the network equipment also comprises:

a receiving module, used for receiving capability confirming information sent from the second network equipment to the first network equipment, wherein the capability confirming information is used for indicating that the second network equipment supports receiving the control signaling from the second interface.

With reference to the fifth aspect or any one of the probable implementations of the fifth aspect, in the fifth probable implementation, the determining module is used for judging whether channel quality between the first network equipment and the second network equipment can satisfy the condition that the second network equipment accurately receives the control signaling according to the channel quality; and instructing the sending module to send the user data of the user equipment to the second network equipment through the first interface, if the first network equipment determines that the channel quality can satisfy the condition that the second network equipment accurately receives the control signaling.

With reference to the fifth aspect or any one of the probable implementations of the fifth aspect, in the sixth probable implementation, the determining module is used for instructing the sending module to send reference signal (RS) to the second network equipment, acquiring the channel quality received by the receiving module, and instructing the sending module to send the user data to the second network equipment through the first interface if the channel quality can satisfy the condition that the second network equipment accurately receives the control signaling; the sending module is further used for sending the reference signal (RS) to the second network equipment according to the instruction of the determining module; and the receiving module is further used for receiving the channel quality informed by the second network equipment, wherein the channel quality is determined by the second network equipment according to the RS; or

the receiving module is further used for receiving RS sent from the second network equipment to the first network equipment; and the determining module is used for determining the channel quality between the first network equipment and the second network equipment according to the RS received by the receiving module, and instructing the sending module to send the user data of the user equipment to the second network equipment through the first interface if the channel quality can satisfy the condition that the second network equipment accurately receives the control signaling.

With reference to the fifth aspect or any one of the probable implementations of the fifth aspect, in the seventh probable implementation, the sending module is further used for sending user equipment information to the second network equipment before sending the control signaling through the second interface, so that the second network equipment detects the control signaling according to the user equipment information.

With reference to the fifth aspect or any one of the probable implementations of the fifth aspect, in the eighth probable implementation, the sending module is further used for sending mode configuration signaling to the user equipment before sending the control signaling through the second interface, the mode configuration signaling is used for indicating that the user equipment receives the control signaling and the user data at the first time period and the second time period; or,

the sending module is further used for sending the control signaling comprising mode configuration signaling through the second interface, wherein the mode configuration signaling is used for indicating that the user equipment receives the control signaling and the user data at the first time period and the second time period,

wherein, the first time period is the one when the user equipment and the second network equipment receive the control signaling, and the second time period is the one when the user equipment receives the user data from the second network equipment.

With reference to the fifth aspect or any one of the probable implementations of the fifth aspect, in the ninth probable implementation, the sending module is used for sending the control signaling comprising processing indicating information through the second interface, wherein the processing indicating information is used for indicating that the user data acquired from the first network equipment is sent to the user equipment according to the control signaling.

With reference to the fifth aspect or any one of the probable implementations of the fifth aspect, in the tenth probable implementation, before instructing the sending module to send the control signaling through the second interface, the determining module is used for determining a transmission time interval (TTI) set and instructing the sending module to send information of the TTI set;

the sending module is further used for sending the information of the TTI set, so that the second network equipment and the user equipment receive the control signaling at a TTI included in the TTI set.

With reference to the tenth probable implementation of the fifth aspect, in the eleventh probable implementation, the sending module is used for sending the information of the TTI set in the following mode: sending the information of the TTI set in a bitmap mode.

With reference to the tenth probable implementation or the eleventh probable implementation of the fifth aspect, in the twelfth probable implementation, the sending module is used for sending the information of the TTI set in the following mode: sending the information of the TTI set through the second interface.

With reference to the fifth aspect or any one of the probable implementations of the fifth aspect, in the twelfth probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the sixth aspect, a user equipment is provided. The user equipment comprises:

a controlling module, used for controlling a receiving module to receive control signaling at a first time period and controlling the receiving module to receive user data at a second time period; and

the receiving module, used for receiving the control signaling sent by a first network equipment at the first time period and receiving the user data sent by a second network equipment according to the control signaling at the second time period according to the control signaling, wherein the first time period and the second time period are discontinuous.

In the first probable implementation of the sixth aspect,

the controlling module is used for controlling the receiving module to receive the control signaling at the first time period and controlling the receiving module to receive the user data at the second time period, wherein the first time period and the second time period are in the same transmission time interval (TTI), the first time period and the second time period are spaced by N_sym symbols, and N_sym is more than or equal to 1 and less than or equal to 12; or

the controlling module is used for controlling the receiving module to receive the control signaling at the first time period and controlling the receiving module to receive the user data at the second time period, wherein the first time period and the second time period are in different transmission time intervals (TTI).

With reference to the sixth aspect or the first probable implementation of the sixth aspect, in the second probable implementation, the controlling module is used for controlling the receiving module to receive the control signaling in a control domain of a first TTI which the first time period is in, and controlling the receiving module to receive the user data in a data domain of a second TTI which the second time period is in.

With reference to the sixth aspect or any one of the probable implementations of the sixth aspect, in the third probable implementation, the receiving module is further used for receiving interval information of the first time period and the second time period sent by the first network equipment, before receiving the control signaling sent by the first network equipment; and the controlling module is used for determining the second time period according to the interval information received by the receiving module and the first time period; or,

the receiving module is further used for receiving information of the second time period sent by the first network equipment, before receiving the control signaling sent by the first network equipment; and the controlling module is used for determining the second time period according to the information of the second time period received by the receiving module.

With reference to the sixth aspect or any one of the probable implementations of the sixth aspect, in the fourth probable implementation, the receiving module is further used for receiving mode configuration signaling sent from the first network equipment to the user equipment, before receiving the control signaling sent by the first network equipment; and the controlling module is further used for controlling the receiving module to receive the control signaling at the first time period and receive the user data at the second time period, according to the mode configuration signaling received by the receiving module; or,

the controlling module is further used for controlling the receiving module to receive the control signaling at the first time period and receive the user data at the second time period according to mode configuration signaling comprised in the control signaling.

With reference to the sixth aspect or any one of the probable implementations of the sixth aspect, in the fifth probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the seventh aspect, a network equipment is provided. The network equipment is a second network equipment, and comprises:

a first interface and a second interface, wherein the second interface is an air interface;

a receiving module, used for receiving user data sent by a first network equipment through the first interface and receiving control signaling sent by the first network equipment through the second interface;

a processing module, used for instructing a sending module to send the user data received by the receiving module according to the control signaling received by the receiving module; and

the sending module, used for sending the user data to user equipment.

In the first probable implementation of the seventh aspect, the sending module is used for sending the user data to the user equipment through the second interface.

With reference to the seventh aspect or the first probable implementation of the seventh aspect, in the second probable implementation, the receiving module is used for receiving the user data sent by the second network equipment at the (n−M)th transmission time interval (TTI) and receiving the control signaling at the nth TTI, wherein M is a positive integer more than or equal to 1, and n is an integer.

With reference to the first probable implementation of the seventh aspect, in the third probable implementation, the first interface is an X2 interface, and M is more than 10.

With reference to the seventh aspect or any one of the probable implementations of the seventh aspect, in the fourth probable implementation, the receiving module is further used for receiving interval information of a first time period and a second time period sent by the first network equipment, before receiving the control signaling sent by the first network equipment; and the processing module is used for determining the second time period according to the interval information received by the receiving module and the first time period, and sending the user data to the user equipment according to the control signaling at the second time period, wherein the first time period is the one when the second network equipment receives the control signaling; or

the receiving module is further used for receiving information of the second time period sent by the first network equipment, before receiving the control signaling sent by the first network equipment; and the processing module is used for determining the second time period according to the information of the second time period received by the receiving module, and instructing the sending module to send the user data according to the control signaling at the second time period, wherein the first time period is the one when the second network equipment receives the control signaling.

With reference to the seventh aspect or any one of the probable implementations of the seventh aspect, in the fifth probable implementation, the processing module is further used for instructing the sending module to send capability confirming information before the receiving module receives the user data, wherein the capability confirming information is used for indicating that the second network equipment supports receiving the control signaling from the second interface;

the sending module is further used for sending the capability confirming information to the first network equipment according to the instruction of the processing module.

With reference to the seventh aspect or any one of the probable implementations of the seventh aspect, in the sixth probable implementation, the receiving module is further used for receiving reference signal (RS) sent from the first network equipment to the second network equipment before receiving the user data sent by the first network equipment through the first interface; the processing module is further used for determining channel quality between the first network equipment and the second network equipment according to the RS; and the sending module is further used for informing the first network equipment of the channel quality; or

the processing module is further used for instructing the sending module to send RS before the user data is received; and the sending module is further used for sending the RS to the second network equipment, so that the first network equipment determines channel quality between the first network equipment and the second network equipment according to the RS.

With reference to the seventh aspect or any one of the probable implementations of the seventh aspect, in the seventh probable implementation, the receiving module is further used for receiving user equipment information sent by the first network equipment before receiving the control signaling;

the receiving module is used for receiving the control signaling in the following mode: detecting and receiving the control signaling according to the user equipment information.

With reference to the seventh aspect or any one of the probable implementations of the seventh aspect, in the eighth probable implementation, the receiving module is further used for receiving a transmission time interval (TTI) set determined by the first network equipment before receiving the control signaling;

the receiving module is used for receiving the control signaling in the following mode: detecting and receiving the control signaling at a TTI included in the TTI set.

With reference to the seventh aspect or any one of the probable implementations of the seventh aspect, in the ninth probable implementation, the processing module is used for instructing the sending module to send the user data in the following mode:

if processing indicating information indicates that the user data acquired from the first network equipment is sent according to the control signaling, instructing the sending module to send the user data according to the control signaling, wherein the control signaling comprises the processing indicating information for indicating that the user data acquired from the first network equipment is sent to the user equipment according to the control signaling.

With reference to the seventh aspect or any one of the probable implementations of the seventh aspect, in the tenth probable implementation, the network equipment further comprises:

a storing module, used for storing the user data sent by the first network equipment and received by the receiving module through the first interface;

the processing module, used for determining the user data corresponding to user equipment information from the storing module according to the user equipment information in the control signaling after the control signaling is received, and sending the user data corresponding to the user equipment information according to the control signaling.

With reference to the seventh aspect or any one of the probable implementations of the seventh aspect, in the eleventh probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the eighth aspect, a network equipment is provided. The network equipment is a first network equipment, and comprises:

a first interface and a second interface, wherein the second interface is an air interface;

a processing module, used for instructing a sending module to send user data of a user equipment to a second network equipment through the first interface, and instructing the sending module to send control signaling through the second interface;

the sending module, used for sending the user data of the user equipment to the second network equipment through the first interface, and sending the control signaling through the second interface, so that the second network equipment sends the user data to the user equipment according to the control signaling, wherein the second interface is the air interface.

In the first probable implementation of the eighth aspect, the sending module is used for sending the user data to the second network equipment at the (n−M)th transmission time interval (TTI), and sending the control signaling at the nth TTI, wherein M is a positive integer more than or equal to 1, and n is an integer.

With reference to the eighth aspect or the first probable implementation of the eighth aspect, in the second probable implementation, the first interface is an X2 interface, and M is more than 10.

With reference to the eighth aspect or any one of the probable implementations of the eighth aspect, in the third probable implementation, before sending the control signaling through the second interface, the sending module is further used for sending interval information of a first time period and a second time period to the user equipment, and sending the interval information of the first time period and the second time period to the second network equipment, wherein the first time period is the one when the first network equipment sends the control signaling, and the second time period is the one when the second network equipment sends the user data; or

before sending the control signaling through the second interface, the sending module is further used for sending information of the second time period to the user equipment, and sending the information of the second time period to the second network equipment, wherein the first time period is the one when the first network equipment sends the control signaling, and the second time period is the one when the second network equipment sends the user data.

With reference to the eighth aspect or any one of the probable implementations of the eighth aspect, in the fourth probable implementation, the network equipment further comprises:

a receiving module, used for receiving capability confirming information sent from the second network equipment to the first network equipment, wherein the capability confirming information is used for indicating that the second network equipment supports receiving the control signaling from the second interface.

With reference to the eighth aspect or any one of the probable implementations of the eighth aspect, in the fifth probable implementation, the processing module is used for judging whether channel quality between the first network equipment and the second network equipment can satisfy the condition that the second network equipment accurately receives the control signaling according to the channel quality; and instructing the sending module to send the user data of the user equipment to the second network equipment through the first interface, if the first network equipment determines that the channel quality can satisfy the condition that the second network equipment accurately receives the control signaling.

With reference to the eighth aspect or any one of the probable implementations of the eighth aspect, in the sixth probable implementation, the processing module is used for instructing the sending module to send reference signal (RS) to the second network equipment, acquiring the channel quality between the first network equipment and the second network equipment received by the receiving module, and instructing the sending module to send the user data to the second network equipment through the first interface if the channel quality can satisfy the condition that the second network equipment accurately receives the control signaling; the sending module is further used for sending the RS to the second network equipment according to the instruction of the processing module; and the receiving module is further used for receiving the channel quality informed by the second network equipment, wherein the channel quality is determined by the second network equipment by measuring the RS; or

the receiving module is further used for receiving RS sent from the second network equipment to the first network equipment; and the processing module is used for determining the channel quality between the first network equipment and the second network equipment according to the RS, and instructing the sending module to send the user data of the user equipment to the second network equipment through the first interface if the channel quality can satisfy the condition that the second network equipment accurately receives the control signaling.

With reference to the eighth aspect or any one of the probable implementations of the eighth aspect, in the seventh probable implementation, the sending module is further used for sending user equipment information to the second network equipment before sending the control signaling through the second interface, so that the second network equipment detects the control signaling according to the user equipment information.

With reference to the eighth aspect or any one of the probable implementations of the eighth aspect, in the eighth probable implementation, the sending module is further used for sending mode configuration signaling to the user equipment before sending the control signaling through the second interface, wherein the mode configuration signaling is used for indicating that the control signaling and the user data are received at the first time period and the second time period; or,

the sending module is further used for sending the control signaling comprising mode configuration signaling through the second interface, wherein the mode configuration signaling is used for indicating that the control signaling and the user data are received at the first time period and the second time period,

wherein, the first time period is the one when the user equipment and the second network equipment receive the control signaling, and the second time period is the one when the user equipment receives the user data from the second network equipment.

With reference to the eighth aspect or any one of the probable implementations of the eighth aspect, in the ninth probable implementation, the sending module is used for sending the control signaling comprising processing indicating information through the second interface, wherein the processing indicating information is used for indicating that the user data acquired from the first network equipment is sent to the user equipment according to the control signaling.

With reference to the eighth aspect or any one of the probable implementations of the eighth aspect, in the tenth probable implementation, before instructing the sending module to send the control signaling through the second interface, the processing module is used for determining a transmission time interval (TTI) set and instructing the sending module to send information of the TTI set;

the sending module is further used for sending the information of the TTI set, so that the second network equipment and the user equipment receive the control signaling at a TTI included in the TTI set.

In combination with the tenth probable implementation of the eighth aspect, in the eleventh probable implementation, the sending module is used for sending the information of the TTI set in the following mode: sending the information of the TTI set in a bitmap mode.

With reference to the tenth probable implementation or the eleventh probable implementation of the eighth aspect, in the twelfth probable implementation, the sending module is used for sending the information of the TTI set in the following mode: sending the information of the TTI set through the second interface.

With reference to the eighth aspect or any one of the probable implementations of the eighth aspect, in the thirteenth probable implementation, the first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

At the ninth aspect, a user equipment is provided. The user equipment comprises:

a processing module, used for controlling a receiving module to receive control signaling at a first time period and controlling the receiving module to receive user data at a second time period; and

the receiving module, used for receiving the control signaling sent by a first network equipment at the first time period and receiving the user data sent by a second network equipment according to the control signaling at the second time period according to the control signaling, wherein the first time period and the second time period are discontinuous.

In the first probable implementation of the ninth aspect, the processing module is used for controlling the receiving module to receive the control signaling at the first time period and controlling the receiving module to receive the user data at the second time period, wherein the first time period and the second time period are in the same transmission time interval (TTI), the first time period and the second time period are spaced by N_sym symbols, and N_sym is more than or equal to 1 and less than or equal to 12; or

the processing module is used for controlling the receiving module to receive the control signaling at the first time period and controlling the receiving module to receive the user data at the second time period, wherein the first time period and the second time period are in different transmission time intervals (TTI).

With reference to the ninth aspect or the first probable implementation of the ninth aspect, in the second probable implementation, the processing module is used for controlling the receiving module to receive the control signaling in a control domain of a first TTI which the first time period is in, and controlling the receiving module to receive the user data in a data domain of a second TTI which the second time period is in.

With reference to the ninth aspect or the first probable implementation of the ninth aspect, in the third probable implementation, the receiving module is further used for receiving interval information of the first time period and the second time period sent by the first network equipment before receiving the control signaling sent by the first network equipment; and the processing module is used for determining the first time period and the second time period according to the interval information and the first time period; or,

the receiving module is further used for receiving information of the second time period sent by the first network equipment before receiving the control signaling sent by the first network equipment; and the processing module is used for determining the second time period according to the information of the second time period received by the receiving module.

With reference to the ninth aspect or the first probable implementation of the ninth aspect, in the fourth probable implementation, the receiving module is further used for receiving mode configuration signaling sent from the first network equipment to the user equipment before receiving the control signaling sent by the first network equipment; and the processing module is further used for controlling the receiving module to receive the control signaling at the first time period and receive the user data at the second time period according to the mode configuration signaling received by the receiving module; or,

the processing module is further used for controlling the receiving module to receive the control signaling at the first time period and receive the user data at the second time period according to mode configuration signaling comprised in the control signaling.

The first network equipment can send the control signaling to the UE and the second network equipment through the air interface, and does not send the control signaling and the data signaling to the second network equipment through the same X2 interface, so that the first interface with longer transmission delay is prevented from being used for sending the control signaling, and the transmission delay of the control signaling between the network equipments is shortened.

### BRIEF DESCRIPTION OF DRAWINGS

To illustrate the technical solutions in the embodiments of the present disclosure more clearly, a brief introduction to the accompanying drawings required in the description of the prior art or the embodiments of the present disclosure will be given below. Apparently, the accompanying drawings described below are merely some embodiments of the present disclosure, and based on which other drawings could be obtained by those skilled in the art.

FIG. 1 is a structural schematic view illustrating a frame for sending control signaling and data signals in the prior art;

FIG. 2 is a flowchart illustrating a data sending method provided in an embodiment of the present disclosure;

FIG. 3 is a flowchart illustrating a data sending method provided in another embodiment of the present disclosure;

FIG. 4 is a flowchart illustrating a data receiving method provided in an embodiment of the present disclosure;

FIG. 5 is a flowchart illustrating a data sending method provided in yet another embodiment of the present disclosure;

FIG. 5a is a flowchart illustrating an implementation of step 501 in FIG. 5;

FIG. 5b is a flowchart illustrating another implementation of step 501 in FIG. 5;

FIG. 6 is a structural schematic view illustrating a frame for sending control signaling and data signals in an embodiment of the present disclosure;

FIG. 7 is a structural schematic view illustrating a frame for sending control signaling and data signals in another embodiment of the present disclosure;

FIG. 8 is a structural schematic view illustrating a network equipment provided in an embodiment of the present disclosure;

FIG. 9 is a structural schematic view illustrating a network equipment provided in another embodiment of the present disclosure;

FIG. 10 is a structural schematic view illustrating a user equipment provided in an embodiment of the present disclosure;

FIG. 11 is a structural schematic view illustrating a network equipment provided in yet another embodiment of the present disclosure;

FIG. 12 is a structural schematic view illustrating a network equipment provided in still yet another embodiment of the present disclosure;

FIG. 13 is a structural schematic view illustrating a user equipment provided in another embodiment of the present disclosure; and

FIG. 14 is a schematic view illustrating transmission of control signaling and user data in an application example of the present disclosure.

### DESCRIPTION OF EMBODIMENTS

To make objectives, technical solutions and advantages of embodiments of the present disclosure more clearly, a clear description of technical solutions of the embodiments of the present disclosure will be given below, in combination with the accompanying drawings in the embodiments of the present disclosure. The embodiments described below are a part, but not all, of the embodiments of the present disclosure. All of other embodiments, obtained by those skilled in the art based on the embodiments of the present disclosure without any inventive efforts, fall into the protection scope of the present disclosure.

An embodiment of the present disclosure provides a data sending method, which can transmit control signaling through an air interface so as to shorten the transmission delay of the control signaling between network equipments, and can transmit data signals through a first interface so as to avoid transmitting excessive information through the air interface and thus reduce the complexity of acquiring the data signals by the network equipment.

The embodiments of the present disclosure are introduced in details below in conjunction with the drawings. The embodiments of the present disclosure and the characteristics in the embodiments can be mutually and randomly combined in case of no conflict.

An embodiment of the present disclosure provides a method for sending data. As shown in FIG. 2, the method comprises the following steps:

At step 210, a first network equipment sends user data to a second network equipment through a first interface.

At step 220, the first network equipment sends control signaling through a second interface, so that the second network equipment sends the user data to a user equipment according to the control signaling, wherein the second interface is an air interface.

In the embodiment of the present disclosure, the user data means data transmitted through a traffic channel, such as data transmitted through a physical downlink shared channel (PDSCH) in a long term evolution (LTE) system. The control signaling is a signaling for scheduling the user data sent to the user equipment, such as a PDCCH in the LTE system. The embodiment of the present disclosure does not limit the specific method for scheduling the user data. For example, the method can comprise the operations of coding and modulating user bit data acquired from the first network equipment and the like, or directly forwarding the user data acquired from the first network equipment, and any method for scheduling the user data can be applied to the embodiment of the present disclosure. Wherein, because the control signaling is sent by the first network equipment through the air interface, both the second network equipment and the UE can receive the control signaling. The control signaling is used for scheduling a resource, and the resource is used for bearing the user data, so that the UE can acquire the resource according to the control signaling and receive the user data borne by the resource.

The second interface is an air interface, wherein the air interface represents a wireless transmission mode supporting a certain transmission standard, for example, the transmission standard is the 3rd generation partnership project (3GPP) LTE, LTE Advanced of the 3GPP LTE, worldwide interoperability for microwave access (WiMAX), IEEE 802.11 or the like.

The first interface is different from the second interface, wherein the first interface can be the wireless transmission mode supporting one of the aforementioned transmission standards, and can also be an interface for wireless transmission via microwave, an interface for wired connection or the like. Wherein the interface for wireless transmission via microwave does not have a transmission standard, and the first network equipment can directly send the user data to the second network equipment through such first interface. As aforementioned, in the prior art, the control signaling and the user data are transmitted between network equipments through the same interface, and the interface can be an X2 interface for transmitting the control signaling and the user data between the network equipments in the prior art. The aforementioned descriptions of the user data, the control signaling, the first interface and the second interface are also applicable to other embodiments of the present disclosure, and are not described hereinafter.

In all the embodiments of the present disclosure, the network equipment can be a base station (BS), an access point (AP), a remote radio equipment (RRE), a remote radio head (RRH), a remote radio unit (RRU), a relay node or the like. The relationship between the network equipments and cells is not limited, one network equipment can correspond to one or more cells, and one cell can also correspond to one or more network equipments.

The first network equipment and the second network equipment can be the same network equipment or different network equipment, and can be any combination of the aforementioned network equipments.

Through the embodiment, the first network equipment can send the control signaling to the UE and the second network equipment through the air interface, and does not transmit the control signaling and data signaling to the second network equipment through the same X2 interface, so that the first interface with longer transmission delay is prevented from being used for transmitting the control signaling, and the transmission delay of the control signaling between the network equipments is shortened. By transmitting the user data through the first interface, excessive information can be prevented from being transmitted through the air interface, so that the complexity of acquiring the user data through the air interface by the network equipment is reduced.

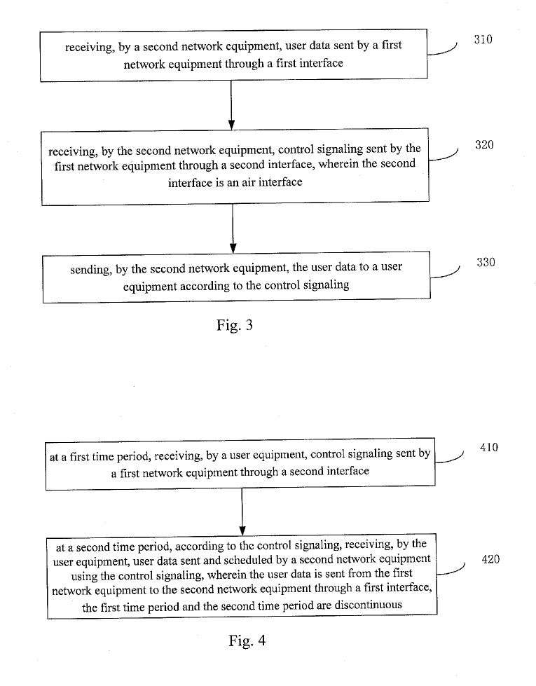

Another embodiment of the present disclosure provides a method for sending data. As shown in FIG. 3, the method comprises the following steps:

At step 310, a second network equipment receives user data sent by a first network equipment through a first interface.

At step 320, the second network equipment receives control signaling sent by the first network equipment through a second interface, wherein the second interface is an air interface.

Step 330, the second network equipment sends the user data to a user equipment according to the control signaling.

Through the present embodiment, the second network equipment can receive the control signaling sent by the first network equipment through the air interface, so that the first interface with longer transmission delay is prevented from being used for transmitting the control signaling, and the transmission delay of the control signaling between the network equipments is shortened. By transmitting the user data through the first interface, excessive information can be prevented from being transmitted through the air interface, so that the complexity of acquiring the user data through the air interface by the network equipment is reduced.

Another embodiment of the present disclosure provides a method for receiving data. As shown in FIG. 4, the method comprises the following steps:

At step 410, at a first time period, a user equipment receives control signaling sent by a first network equipment.

At step 420, at a second time period, according to the control signaling, the user equipment receives user data sent by a second network equipment according to the control signaling, wherein the first time period and the second time period are discontinuous.

In the step 420, the user data is received from the first network equipment by the second network equipment through the first interface.

Through the embodiment, the user equipment can receive the control signaling sent by the first network equipment and the user data sent by the second network equipment at two discontinuous time periods, so that the second network equipment has enough time for scheduling the user data. Moreover, the user data is sent from the first network equipment to the second network equipment through the first interface. Alternatively, the control signaling is received from the first network equipment by the second network equipment through the second interface (the air interface), so that the first interface with longer transmission delay is prevented from being used for transmitting the control signaling, and the transmission delay of the control signaling between the network equipments is shortened.

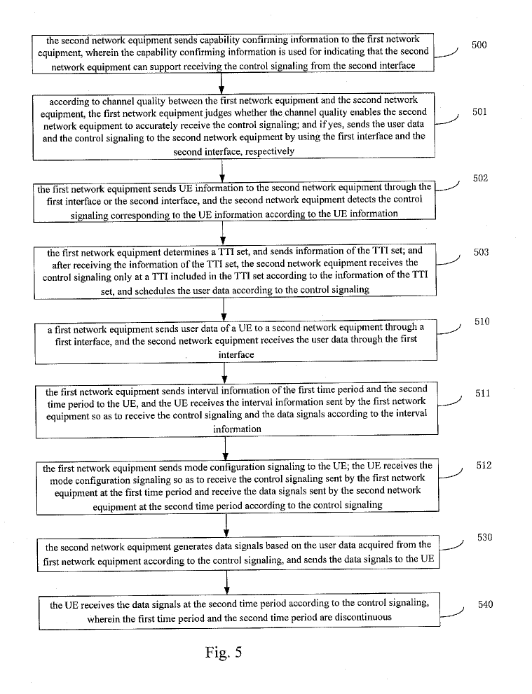

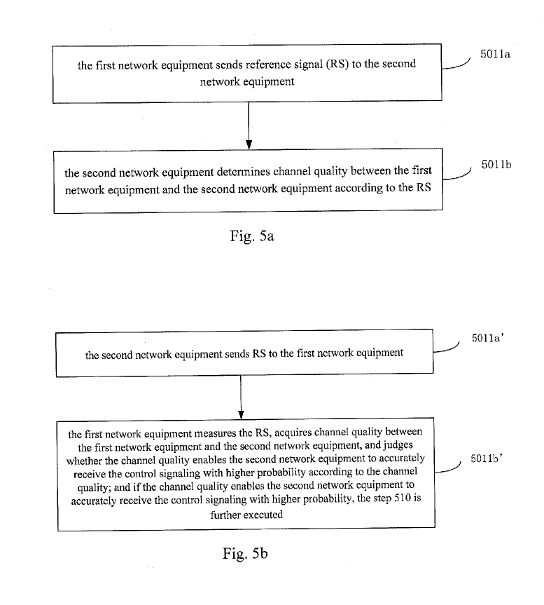

Another embodiment of the present disclosure provides a method for sending data. As shown in FIG. 5, the method comprises the following steps:

At step 510, a first network equipment sends user data of a UE to a second network equipment through a first interface, and the second network equipment receives the user data through the first interface.

At step 520, the first network equipment sends control signaling through a second interface, the second network equipment receives the control signaling through the second interface, and the UE receives the control signaling at a first time period, wherein the second interface is an air interface.

At step 530, the second network equipment generates data signals based on the user data acquired from the first network equipment according to the control signaling, and sends the data signals to the UE.

The second network equipment can send the data signals to the user equipment through an air interface, the air interface supports the same transmission standard as the second interface, for example, both the two interfaces have the transmission mode supporting the 3GPP LTE standard, so that the UE can acquire the control signaling and acquire the data signals according to the control signaling through the same interface.

In this step, when the second network equipment schedules the user data acquired from the first network equipment according to the control signaling, the embodiment of the present disclosure does not limit the specific method for scheduling the user data. For example, the method can comprise the operations of coding and modulating user bit data acquired from the first network equipment and the like, or directly forwarding the user data acquired from the first network equipment, and any method for scheduling the user data can be applied to the embodiments of the present disclosure and is not described herein.

In the embodiments of the present disclosure, the user data means data sent through a traffic channel, such as data sent through a physical downlink shared channel (PDSCH) in an LTE system. The control signaling, such as a physical downlink control channel (PDCCH) in the LTE system, is a signaling for scheduling the user data sent to the user equipment.

Further, the step 530 can comprise:

after receiving the control signaling, the second network equipment determines user data corresponding to UE information according to the UE information in the control signaling, schedules the user data acquired from the first network equipment according to the control signaling, and sends data signals generated by using the user data to the UE.

Wherein, when the first network equipment sends the control signaling, the UE information will be loaded in the control signaling, so that the second network equipment and the UE can acquire the corresponding control signaling.

Moreover, the second network equipment may receive the user data of multiple UEs. In this way, the second network equipment will determine the user data corresponding to UE information according to the UE information in the control signaling, and thus schedule the corresponding user data. For example, the first network equipment sends user data of two UEs to the second network equipment in advance, and loads radio network temporary identity (RNTI) information of the UE1 in the control signaling; and after receiving the control signaling sent by the first network equipment, the second network equipment detects and learns the RNTI of the UE1 included in the control signaling, determines the user data corresponding to the UE1 from the user data of the two UEs, and then sends the generated data signals after processing.

The first network equipment can send the user data to the second network equipment at the (n−M)^{th} TTI and send the control signaling at the nth TTI, wherein M is a positive integer and is more than or equal to 1 and less than or equal to 12, and n is an integer.

The first network equipment sends the user data to the second network equipment ahead of the control signaling, so that if the transmission delay of the first network equipment and the second network equipment is less than M TTIs, the second network equipment can acquire the user data ahead of the nth TTI and receive the control signaling sent by the first network equipment at the nth TTI.

Further, if the first interface is an X2 interface, preferably, M is more than 10.

For example, in the LTE system, the first interface is the X2 interface. And generally, the delay of sending information to the second network equipment through the X2 interface by the first network equipment is more than 10 ms (namely 10 TTIs), so M is more than 10 to satisfy the communication of the X2 interface.

Step 540, the UE receives the data signals at the second time period according to the control signaling, wherein the first time period and the second time period are discontinuous.

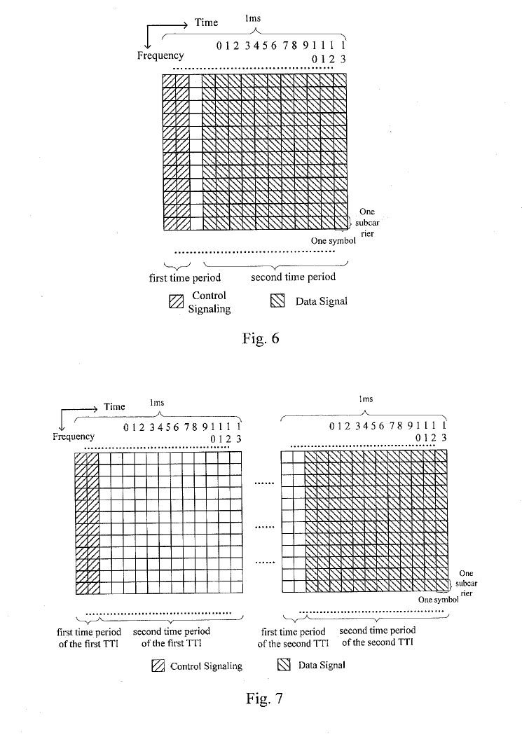

In an implementation, the first time period and the second time period are in the same TTI, and the first time period and the second time period are spaced by N_sym symbols, wherein N_sym is more than or equal to 1 and less than or equal to 4. FIG. 6 shows the condition that N_sym is equal to 1. The first time period comprises the first 2 OFDM symbols, and the second time period comprises the last 11 OFDM symbols; and the user equipment receives the control signaling sent by the first network equipment in the first 2 OFDM symbols of a TTI, and receives the data signals sent by the second network equipment in the last 11 OFDM symbols of the TTI after the duration of 1 OFDM. In this implementation, the control signaling is in the first two symbols in one TTI, so the design keeps the characteristics in the prior art. Namely, the control signaling and the data signals are in the same TTI and are distinguished through different symbols on time, and the design has good compatibility with the prior art.

The value of N_sym is fixed and can be preset at the second network equipment side and the UE side, so that the second network equipment and the UE can carry out corresponding receiving and sending operations; and the value of N_sym can also be determined in a negotiated mode.

In another implementation, the first time period and the second time period can be in different TTIs. FIG. 7 shows an example that the first time period is in the first TTI and the second time period is in the second TTI. Because the second network equipment needs to decode the control signaling at the interval of the first time period and the second time period and schedule the user data according to the acquired control signaling, if the interval only comprises multiple symbols and the first time period and the second time period are in the same TTI, higher requirement is brought to the second network equipment. Thus, in a way that the UE receives the control signaling and the data signals at two time periods in different TTIs, the requirement for quick processing for the second network equipment is reduced.

Further, the first time period is in the control domain of the first TTI, namely, the first two symbols of a TTI, and the second time period is in the data domain of the second TTI, namely, the last 12 symbols of another TTI. FIG. 7 shows the example that the first time period is in the first two symbols of the first TTI and the second time period is in the last 12 symbols of the second TTI, namely, the first time period is in the control domain of the first TTI and the second time period is in the data domain of the second TTI. In this way, the design can be kept consistent with the prior art as much as possible, namely, for any TTI, the design does not change the designs of the control domain and the data domain in the prior art and thus has higher compatibility with the prior art.

The first TTI and the second TTI only represent different TTIs. They are not limited as two continuous TTIs, and can also be discontinuous TTIs.

In the embodiment of the present disclosure, the first network equipment can send the control signaling to the UE and the second network equipment through the air interface, so that the first interface with longer transmission delay is prevented from being used for transmitting the control signaling, and the transmission delay of the control signaling between the network equipments is shortened. By transmitting the user data through the first interface, excessive information can be prevented from being transmitted through the air interface, so that the complexity of acquiring the user data through the air interface by the network equipment is reduced.

Alternatively, before the step 520, the method provided in the embodiment of the present disclosure can also comprise:

Step 511, the first network equipment sends interval information of the first time period and the second time period to the UE, and the UE receives the interval information sent by the first network equipment, so as to receive the control signaling and the data signals according to the interval information.

Further, the first network equipment also sends the interval information of the first time period and the second time period to the second network equipment, and the second network equipment receives the interval information sent by the first network equipment, so as to send the data signals according to the interval information.

For example, if the interval is 2 symbols, the first network equipment sends the interval information with the interval being 2 symbols to the UE, and the UE waits for 2 symbols after receiving the control signaling at the first time period and then receives the data signals according to the interval information.

Moreover, in this step, the first network equipment can send information of the second time period, which replaces the interval information, to the UE and the second network equipment. The information of the first time period is configured in advance, and both the network equipment and the UE can determine the first time period, so that the UE and the second network equipment can determine the second time period through the method provided in this step.

The step 511 can be executed before or after the step 510.

Alternatively, before the step 510, the method provided in the embodiment of the present disclosure can also comprise:

Step 500, the second network equipment sends capability confirming information to the first network equipment, wherein the capability confirming information is used for indicating that the second network equipment can support receiving the control signaling from the second interface.

After receiving the capability confirming information, the first network equipment sends the control signaling and the user data to the second network equipment by using the method provided in the embodiment of the present disclosure.

The capability confirming information can be realized in multiple modes. For example, the capability confirming information is a flag with one bit. The flag with a value of 1 represents that the second network equipment can receive the control signaling through the second interface and receive the user data through the first interface, and after receiving the capability confirming information, the first network equipment can carry out related operations by using the method provided in the embodiment of the present disclosure. Moreover, if the flag is represented as 0, the first network equipment can send the control signaling and the user data to the UE according to the method provided in the prior art, and does not send the user data to the UE through the second network equipment.

Alternatively, before the step 510, the method provided in the embodiment of the present disclosure can also comprise:

At step 501, according to the channel quality between the first network equipment and the second network equipment, the first network equipment judges whether the channel quality enables the second network equipment to accurately receive the control signaling; and if the channel quality enables the second network equipment to accurately receive the control signaling with higher probability (e.g., 99%), the control signaling and the user data are sent respectively by using the second interface and the first interface, namely, the step 510 is further executed.

Through the method of the step 501, the second network equipment can reliably enough receive the control signaling sent by the first network equipment through the air interface, thus it can ensure that the whole mechanism of the embodiment of the present disclosure can well work.

The step 501 and the capability confirming information of the step 500 can be used together for determining whether the control signaling and the user data can be sent to the second network equipment by using the method provided in the embodiment of the present disclosure, namely, if the channel quality enables the second network equipment to accurately receive the control signaling with higher probability and the capability confirming information indicates that the second network equipment can support receiving the control signaling from the second interface, the step 510 is executed.

Wherein, as shown in FIG. 5a, the step 501 can further comprise:

At step 5011a, the first network equipment sends reference signal (RS) to the second network equipment.

At step 5012b, the second network equipment determines channel quality between the first network equipment and the second network equipment according to the RS.

Specifically, the second network equipment can measure the RS, determine channel quality information between the first network equipment and the second network equipment and send the channel quality information to the first network equipment; the first network equipment judges whether the channel quality enables the second network equipment to accurately receive the control signaling according to the channel quality information; and if the channel quality enables the second network equipment to accurately receive the control signaling with higher probability, the control signaling and the user data are sent respectively by using the second interface and the first interface, namely, the step 510 is further executed.

Moreover, the first network equipment can also send configuration information of the RS to the second network equipment, so that the second network equipment acquires parameters of the RS sent by the first network equipment and then measures the RS sent by the first network equipment. In this way, the measurement is relatively stable and reliable. Or, the second network equipment determines the RS sent by the first network equipment through a blind detection method, so that the information sent from the first network equipment to the second network equipment can be saved. For example, a configuration for selecting only one from multiple downlink synchronous signals according to the cell identity (ID) is preset in the network equipment, in this way, the second network equipment can carry out blind detection on the downlink synchronous signal according to the configuration. Thus, the second network equipment can judge the cell ID corresponding to the first network equipment, determine the RS sent by the first network equipment according to the cell ID and measure the RS.

Or, as shown in FIG. 5b, the step 501 can further comprise:

Step 5011a′, where the second network equipment sends the RS to the first network equipment,

Step 5012b′, where the first network equipment measures the RS, acquires the channel quality between the first network equipment and the second network equipment and judges whether the channel quality enables the second network equipment to accurately receive the control signaling with higher probability according to the channel quality. If the channel quality enables the second network equipment to accurately receive the control signaling with higher probability, the first network equipment sends the control signaling and the user data to the second network equipment by using the method provided in the embodiment of the present disclosure, namely, the step 510 is further executed.

The second network equipment can also send configuration information of the RS to the first network equipment; or the first network equipment determines the RS sent by the second network equipment through a blind detection method, the specific description of which can refer to the aforementioned.

The RS can be a common reference signal (CRS) in an LTE system, a channel state information-reference signal (CSI-RS) in an LTE-Advanced system or the like.

The channel quality information is the one for reflecting whether a channel is beneficial to transmission, such as an indicator for reflecting received signal intensity or disturbance intensity, and the channel quality information can comprise at least one of a signal interference noise ratio (SINR), a channel quality indicator (CQI) and a reference signal received power (RSRP).

The embodiment of the prevent disclosure does not limit the interface for sending the channel quality information, the configuration information of the RS or the RS, for example, the interface can be the first interface or the second interface, or other interface.

Alternatively, before the step 510, the method provided in the embodiment of the present disclosure can also comprise:

At step 502, the first network equipment sends UE information to the second network equipment through the first interface or the second interface, and the second network equipment detects the control signaling corresponding to the UE information according to the UE information.

In this step, on the one hand, the UE information can be used for indicating the UE required to be detected by the second network equipment to the second network equipment; and on the other hand, the UE information can also be used for triggering the second network equipment to process the UE corresponding to the UE information according to the method provided in the embodiment of the present disclosure, namely, for the UE corresponding to the UE information, the step 510 is executed.

A network comprises multiple UEs, the second network equipment generally sends the data signals to a part of the UEs, a good channel condition is generally formed between the UEs and the second network equipment, such as the UE closer to the second network equipment, and the first network equipment generally can determine the UE with good channel condition with the second network equipment after receiving the measurement report reported by the UE, and therefore, the first network equipment can send the UE information of the UE to the second network equipment, so that the second network equipment only needs to detect the control signaling of the UE corresponding to the UE information and carry out the subsequent operations. In this way, the complexity of the second network equipment is reduced. Moreover, for a scene using the CoMP technology, the first network equipment and the second network equipment generally only serve a part of UEs in a coordinated mode, and therefore, such design can also reduce the complexity of the second network equipment in the CoMP scene.

The UE information can also be not sent, and under this condition, the second network equipment can detect the control signaling corresponding to all the UE information owned by the second network equipment.

The UE information can be a RNTI of the UE. Generally, the RNTIs of all the UE served by the same network equipment are different from each other. The network equipment sends the control signaling, and if the control signaling is used for scheduling downlink data for a certain UE, the RNTI of the UE is generally loaded, so that the UE can confirm whether the control signaling is used for scheduling its own downlink data. In the embodiment of the present disclosure, the first network equipment loads the RNTI of the scheduled UE in the sent control signaling, and the second network equipment can detect the control signaling by using the RNTI of the UE sent from the first network equipment to the second network equipment in advance. If the second network equipment detects the control signaling corresponding to the RNTI of the UE, the user data corresponding to the UE is scheduled according to the detected control signaling. The method for loading the RNTI can be any implementation in the prior art, for example, exclusive OR operation is carried out on the RNTI of the UE and the cyclic redundancy check (CRC) bit of the control signaling, which is not described herein.

Further, in the step 520, the control signaling sent by the first network equipment through the second interface can comprise processing indicating information, wherein the processing indicating information is used for indicating whether the second network equipment sends the user data acquired from the first network equipment to the user equipment according to the control signaling. The second network equipment detects the control signaling, and judges according to the processing indicating information whether the user data acquired from the first network equipment is processed according to the control signaling; and if the processing indicating information indicates that the user data acquired from the first network equipment is processed according to the control signaling, the step 530 is executed.

The processing indicating information can be realized in multiple modes.

For example, one flag can be added at a fixed bit position in the control signaling, and the flag with a value of 1 is used for instructing the second network equipment to schedule the user data acquired from the first network equipment according to the control signaling and send the generated data signals. Through the processing indicating information, the first network equipment can also control the second network equipment to only schedule the user data corresponding to a part of UEs.

For another example, the processing indicating information can be identity (ID) corresponding to the second network equipment. Each network equipment corresponds to one ID. If the processing indicating information is the ID of the second network equipment, after the second network equipment receives the processing indicating information, the second network equipment can confirm that the second network equipment itself needs to schedule the user data acquired from the first network equipment according to the ID and send the generated data signals. For the scene that the first network equipment is connected with multiple second network equipments, the processing indicating information enables each of the multiple second network equipment to respectively identify the control signaling corresponding to the user data which needs to be scheduled by the second network equipment itself, so that the first network equipment can send the data signals to the UE through the second network equipment more flexibly. The ID corresponding to the second network equipment can be sent in advance from the second network equipment to the first network equipment, or is preset by the first network equipment, or is the cell ID corresponding to the second network equipment.

Moreover, the processing indicating information can be used with the UE information in the step 502. For example, after the second network equipment receives the UE information, the second network equipment detects the control signaling corresponding to the UE information, and judges whether the user data of the user equipment corresponding to the detected control signaling is scheduled by the second network equipment according to the processing indicating information in the detected control signaling.

Alternatively, before or in the step 520, the method provided in the embodiment of the present disclosure can also comprise:

At step 512, the first network equipment sends mode configuration signaling to the UE, wherein the mode configuration signaling is used for instructing the UE to receive the control signaling and the data signals at the first time period and the second time period; and the UE receives the mode configuration signaling so as to receive the control signaling sent by the first network equipment at the first time period and receive the data signals sent by the second network equipment at the second time period according to the control signaling.

In the embodiment of the present disclosure, the step 511 can be executed at any time before the step 520. Herein, the step 511 is exemplified after the step 510, but is not limited to being executed after the step 510.

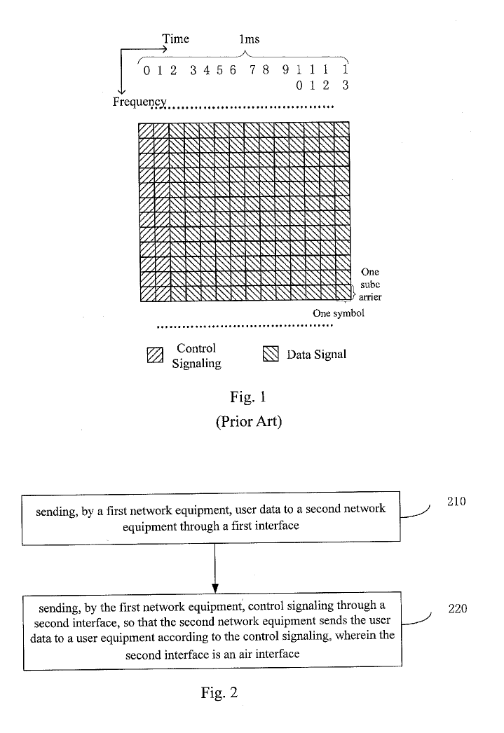

Because the time periods when the UE receives the control signaling and the data signals sent by the network equipment are discontinuous in the embodiment of the present disclosure, the first network equipment can send mode configuration signaling to the UE, so that the UE determines which time period in the embodiment of the present disclosure is used for receiving the control signaling and the data signals according to the mode configuration signaling. For example, for the embodiment shown in FIG. 6, the UE detects the control signaling in the first 2 symbols in a TTI and detects the data signals in the last 11 symbols in the TTI. For another example, for the embodiment shown in FIG. 7, the UE detects the control signaling in the first 2 symbols of a first TTI and detects the data signals in the last 12 symbols of a second TTI. If the mode configuration signaling indicates that the UE receives the control signaling and the data signals at the time periods in the prior art, the UE detects the control signaling in the first 2 symbols in a TTI and detects the data signals in the last 12 symbols in the TTI according to a mode shown in FIG. 1.

The first network equipment can also send the mode configuration signaling to the UE in the control signaling. For example, the mode configuration signaling is sent to the UE in a PDCCH of an LTE system; and because the PDCCH is dynamically sent to the UE by the network equipment, a receiving mode can be dynamically configured for the UE by sending the mode configuration signaling in the control signaling, and thus flexibility is brought to the system. Under this condition, the mode configuration signaling can be in the same information bit as the aforementioned processing indicating information. For example, the information bit only comprises one flag, and the flag with a value of 1 is used for instructing the second network equipment to schedule user data acquired from the first network equipment according to the control signaling, and send the generated data signals; and the information bit instructs the UE to receive the control signaling and the data signals at the first time period and the second time period. In such a way, two instructions can be made through one signaling, so that the signaling overhead is reduced.

Alternatively, before the step 510, the method provided in the embodiment of the present disclosure can also comprise:

At step 503, the first network equipment determines a TTI set, and sends information of the TTI set; and after the second network equipment receives the information, the second network equipment receives the control signaling only at a TTI included in the TTI set according to the information of the TTI set, and schedules the user data according to the control signaling.

For example, in the LTE system, one TTI is one subframe, and one radio frame comprises 10 subframes. The first network equipment determines the 3rd and 5th subframes in the radio frame, which use the method provided in the embodiment of the present disclosure, and sends the information of the 3rd and 5th subframes to the second network equipment; and the second network equipment detects the control signaling sent by the first network equipment only in the 3rd and 5th subframes, and executes subsequent processing according to the control signaling.

The first network equipment can send the information of the TTI set in a bitmap mode. The sending mode is not only limited to the bitmap mode, for example, the serial number of the TTI can be directly sent and the like.

For example, one frame comprises 10 subframes; and the first network equipment sends 10 bits to the second network equipment, and each bit indicates whether the second network equipment can receive the control signaling sent by the first network equipment in the corresponding subframe. For example, the bit of 1 represents AVAILABLE, the bit of 0 represents NON-AVAILABLE, the 10 bits sent from the first network equipment to the second network equipment are 0010100101 respectively, and the second network equipment is instructed to receive the control signaling sent by the first network equipment in the 2nd, 4th, 7th and 9th subframes, wherein the 10 subframes are numbered from 0.

The first network equipment can send the information of the TTI set through the second interface.

Through such method, the second network equipment can use the method provided in the embodiment of the present disclosure only in a part of TTIs, so that the second network equipment can be simplified.

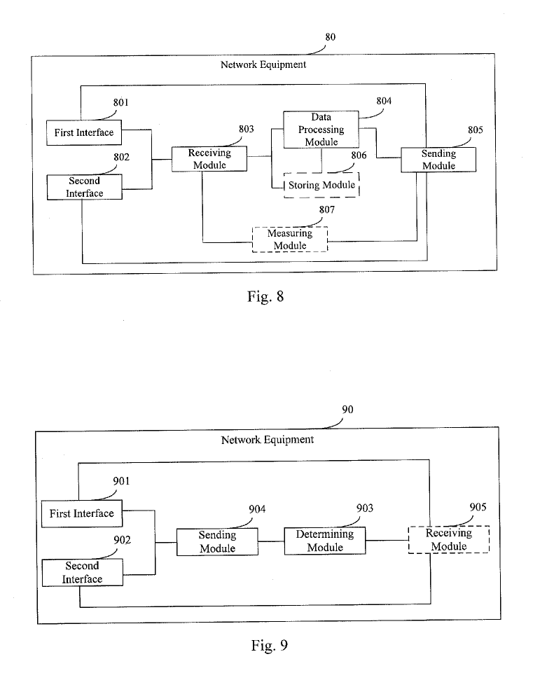

An embodiment of the present disclosure provides a network equipment 80, and the network equipment 80 can execute the steps included in the methods of the aforementioned embodiments. The embodiment only simply describes the structure of the network equipment 80, the specific implementation of which can be obtained by referring to the description in the aforementioned embodiments. As shown in FIG. 8, the network equipment is second network equipment, and the network equipment 80 comprises a first interface 801, a second interface 802, a receiving module 803, a data processing module 804 and a sending module 805.

The second interface 802 is an air interface;

the receiving module 803 is used for receiving user data sent by a first network equipment through the first interface and receiving control signaling sent by the first network equipment through the second interface;

the data processing module 804 is used for acquiring the control signaling received by the receiving module and instructing the sending module to send the user data received by the receiving module; and

the sending module 805 is used for sending the user data to a user equipment.

By using the network equipment provided in the embodiment of the present disclosure, the control signaling can be sent through the air interface, so that the transmission delay of the control signaling between the network equipments is shortened; and the user data is sent through the first interface, so that excessive information can be prevented from being sent through the air interface, and the complexity of acquiring the user data by the network equipment is reduced. Specifically, the network equipment 80 provided in this embodiment can execute the steps provided in the embodiment of the aforementioned method. Thus, by referring to the description of the embodiments of the aforementioned methods, the technical effects of the network equipment 80 can be obtained, which are not described herein.

The sending module 805 can be used for sending the user data to the user equipment through the second interface 802.

Further, the receiving module 803 is used for receiving the user data sent by the second network equipment at the (n−M)th transmission time interval (TTI) and receiving the control signaling at the nth TTI, wherein M is a positive integer more than or equal to 1, and n is an integer.

Further, the first interface is an X2 interface, and M is more than 10.

Further, the receiving module 803 can further be used for receiving interval information of a first time period and a second time period sent by the first network equipment, before receiving the control signaling sent by the first network equipment; and the data processing module 804 is used for determining the second time period according to the interval information received by the receiving module 803 and the first time period, and instructing the sending module 805 to send the user data to the user equipment according to the control signaling at the second time period, wherein the first time period is the one when the second network equipment receives the control signaling; or

the receiving module 803 is further used for receiving information of a second time period sent by the first network equipment before receiving the control signaling sent by the first network equipment is received; and the data processing module 804 is used for determining the second time period according to the information of the second time period received by the receiving module and instructing the sending module 805 to send the user data according to the control signaling at the second time period, wherein the first time period is the one when the second network equipment receives the control signaling.

Further, the data processing module 804 can further be used for instructing the sending module 805 to send capability confirming information before the user data is received, wherein the capability confirming information is used for indicating to the first network equipment that the second network equipment supports receiving the control signaling from the second interface 802;

the sending module 805 can further be used for sending the capability confirming information to the first network equipment.

The network equipment can further comprise: a storing module 806, used for storing the user data sent by the first network equipment and received by the receiving module 803 through the first interface;

the data processing module 804, used for determining the user data corresponding to user equipment information from the storing module 806 according to the user equipment information in the control signaling after the control signaling is received, and sending the user data corresponding to the user equipment information according to the control signaling.

Further, the network equipment can further comprise a measuring module 807;

the receiving module 803 can further be used for receiving RS sent from the first network equipment to the second network equipment before receiving the user data sent by the first network equipment through the first interface 801;

the measuring module 807 can be used for determining channel quality between the first network equipment and the second network equipment according to the RS received by the receiving module 803; and the sending module 805 is further used for informing the first network equipment of the channel quality determined by the measuring module 807; or

the data processing module 804 can further be used for instructing the sending module 805 to send RS before the user data is received; and the sending module 805 can further be used for sending the RS to the second network equipment, so that the first network equipment determines channel quality between the first network equipment and the second network equipment according to the RS.

Further, the receiving module 803 can further be used for receiving user equipment information sent by the first network equipment through the first interface 801 or the second interface 802 before receiving the control signaling;

the receiving module 803 can be used for receiving the control signaling in the following mode: detecting and receiving the control signaling according to the user equipment information.

Further, the receiving module 803 can further be used for receiving a transmission time interval (TTI) set determined by the first network equipment before receiving the control signaling;

the receiving module 803 can be used for receiving the control signaling in the following mode: detecting and receiving the control signaling at a TTI included in the TTI set.

The data processing module 804 can be used for instructing the sending module to send the user data received by the receiving module 803 in the following mode:

if processing indicating information indicates that the user data acquired from the first network equipment is scheduled according to the control signaling, instructing the sending module 805 to send the user data according to the control signaling, wherein the control signaling comprises the processing indicating information for indicating that the user data acquired from the first network equipment is sent to the user equipment according to the control signaling.

The first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

Another embodiment of the present disclosure provides a network equipment 90, and the network equipment 90 can execute the steps included in the methods of the aforementioned embodiments. The embodiment only simply describes the structure of the network equipment 90, the specific implementation of which can be obtained by referring to the description in the aforementioned embodiments. As shown in FIG. 9, the network equipment is a first network equipment, and the network equipment 90 comprises a first interface 901, a second interface 902, a determining module 903 and a sending module 904.

The second interface 902 is an air interface;

the determining module 903 is used for instructing the sending module 904 to send user data of a user equipment to a second network equipment through the first interface 901, and instructing the sending module 904 to send control signaling through the second interface 902;

the sending module 904 is used for sending the user data of the user equipment to the second network equipment through the first interface 901, and sending the control signaling through the second interface 902, so that the second network equipment sends the user data to the user equipment according to the control signaling, wherein the second interface 902 is the air interface.

The network equipment 90 provided in the embodiment can execute the steps included in the embodiment of the aforementioned method. Thus, by referring to the description of the embodiments of the aforementioned methods, the technical effects of the network equipment 90 can be obtained, which are not described herein.

Further, the sending module 904 is used for sending the user data to the second network equipment at the (n−M)th transmission time interval (TTI) and sending the control signaling at the nth TTI, wherein M is a positive integer more than or equal to 1, and n is an integer.

The first interface 901 can be an X2 interface, and M is more than 10.

Further, the sending module 904 is further used for, before sending the control signaling through the second interface 902, sending interval information of a first time period and a second time period to the user equipment, and sending the interval information of the first time period and the second time period to the second network equipment; or

the sending module 904 is further used for, before sending the control signaling through the second interface, sending information of the second time period to the user equipment, and sending the information of the second time period to the second network equipment,

wherein, the first time period is the one when the first network equipment sends the control signaling, and the second time period is the one when the second network equipment sends the user data.

Further, the network equipment 90 can further comprise:

a receiving module 905, used for receiving capability confirming information sent from the second network equipment to the first network equipment, wherein the capability confirming information is used for indicating that the second network equipment supports receiving the control signaling from the second interface 902.

Further, the determining module 903 is used for judging whether channel quality between the first network equipment and the second network equipment can satisfy the condition that the second network equipment accurately receives the control signaling according to the channel quality; and instructing the sending module 904 to send the user data of the user equipment to the second network equipment through the first interface 901, if the first network equipment determines that the channel quality can satisfy the condition that the second network equipment accurately receives the control signaling.

Further, the determining module 903 is used for instructing the sending module 904 to send reference signal (RS) to the second network equipment, acquiring the channel quality received by the receiving module 905, and instructing the sending module 904 to send the user data to the second network equipment through the first interface 901 if the channel quality can satisfy the condition that the second network equipment accurately receives the control signaling; the sending module 904 is further used for sending the reference signal (RS) to the second network equipment according to the instruction of the determining module 903; and the receiving module 905 is further used for receiving the channel quality informed by the second network equipment, wherein the channel quality is determined by the second network equipment according to the RS; or

the receiving module 905 is further used for receiving the RS sent from the second network equipment to the first network equipment; and the determining module 903 is used for determining the channel quality between the first network equipment and the second network equipment according to the RS received by the receiving module 905, and instruction the sending module 904 to send the user data of the user equipment to the second network equipment through the first interface 901 if the channel quality can satisfy the condition that the second network equipment accurately receives the control signaling.

Further, the sending module 904 is further used for sending user equipment information to the second network equipment through the first interface 901 or the second interface 902, so that the second network equipment detects the control signaling according to the user equipment information.

Further, the sending module 904 is further used for sending mode configuration signaling to the user equipment before sending the control signaling through the second interface 902, wherein the mode configuration signaling is used for indicating that the user equipment receives the control signaling and the user data at the first time period and the second time period; or,

the sending module 904 is further used for sending the control signaling comprising mode configuration signaling through the second interface 902, wherein the mode configuration signaling is used for indicating that the user equipment receives the control signaling and the user data at the first time period and the second time period,

wherein, the first time period is the one when the user equipment and the second network equipment receive the control signaling, and the second time period is the one when the user equipment receives the user data from the second network equipment.

Further, the sending module 904 is used for sending the control signaling comprising processing indicating information through the second interface 902, wherein the processing indicating information is used for indicating that the user data acquired from the first network equipment is sent to the user equipment according to the control signaling.

Further, before instructing the sending module 904 to send the control signaling through the second interface 902, the determining module 903 is used for determining a transmission time interval (TTI) set, and instructing the sending module 904 to send information of the TTI set;

the sending module 904 is further used for sending the information of the TTI set, so that the second network equipment and the user equipment receive the control signaling only at a TTI included in the TTI set.

Further, the sending module 904 is used for sending the information of the TTI set in the following mode: sending the information of the TTI set in a bitmap mode.

Further, the sending module 904 is used for sending the information of the TTI set in the following mode: sending the information of the TTI set through the second interface 902.

The first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

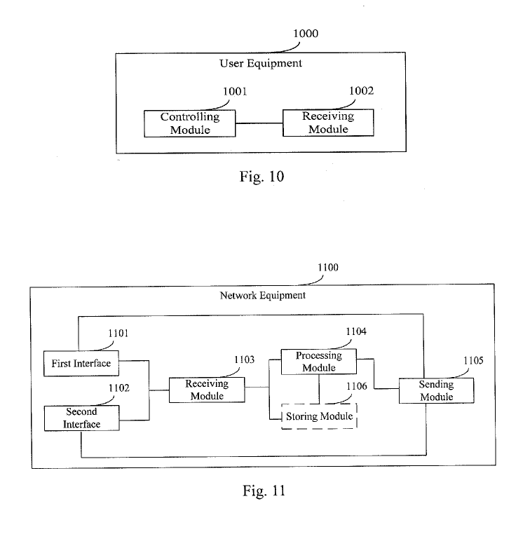

An embodiment of the present disclosure provides a user equipment 1000, and the user equipment 1000 can execute the steps included in the methods of the aforementioned embodiments. The embodiment only simply describes the structure of the user equipment 1000, the specific implementation of which can be obtained by referring to the description in the aforementioned embodiments. As shown in FIG. 10, the user equipment 1000 comprises a controlling module 1001 and a receiving module 1002.

The controlling module 1001 is used for controlling the receiving module 1002 to receive control signaling at a first time period and controlling the receiving module 1002 to receive user data at a second time period; and

the receiving module 1002 is used for receiving the control signaling sent by a first network equipment at a first time period and receiving the user data sent by a second network equipment according to the control signaling at a second time period according to the control signaling, wherein the first time period and the second time period are discontinuous.

The user equipment 1000 provided in the embodiment can execute the steps included in the embodiment of the aforementioned method. Thus, by referring to the description of the embodiments of the aforementioned methods, the technical effects of the user equipment 1000 can be obtained, which are not described herein.

Further, the controlling module 1001 is used for controlling the receiving module 1002 to receive the control signaling at the first time period and controlling the receiving module 1002 to receive the user data at the second time period, wherein the first time period and the second time period are in the same transmission time interval (TTI), the first time period and the second time period are spaced by N_sym symbols, and N_sym is more than or equal to 1 and less than or equal to 12; or

the controlling module 1001 is used for controlling the receiving module 1002 to receive the control signaling at the first time period and controlling the receiving module 1002 to receive the user data at the second time period, wherein the first time period and the second time period are in different transmission time intervals (TTI).

Further, the controlling module 1001 is used for controlling the receiving module 1002 to receive the control signaling in a control domain of a first TTI which the first time period is in, and controlling the receiving module 1002 to receive the user data in a data domain of a second TTI which the second time period is in.

Further, the receiving module 1002 is further used for receiving interval information of the first time period and the second time period sent by the first network equipment before receiving the control signaling sent by the first network equipment;

the controlling module 1001 is used for determining the second time period according to the interval information received by the receiving module and the first time period or according to information of the second time period; or,

the receiving module 1002 is further used for, before receiving the control signaling sent by the first network equipment, receiving the information of the second time period sent by the first network equipment, and sending the information of the second time period to the controlling module; and the controlling module 1001 is used for determining the second time period according to the information of the second time period.

Further, the receiving module 1002 is further used for receiving mode configuration signaling sent from the first network equipment to the user equipment, before receiving the control signaling sent by the first network equipment; and the controlling module 1001 is further used for controlling the receiving module 1002 to receive the control signaling at the first time period and receive the user data at the second time period, according to the mode configuration signaling received by the receiving module 1002; or,

the controlling module 1001 is further used for controlling the receiving module 1002 to receive the control signaling at the first time period and receive the user data at the second time period according to mode configuration signaling comprised in the control signaling.

Moreover, the embodiment of the present disclosure further provides a data transmitting system, comprising the network equipment 80, the network equipment 90 and the user equipment 1000 in the aforementioned embodiments, the specific implementations of which can be obtained by referring to the description in the embodiments, and are not described herein.

Another embodiment of the present disclosure provides a network equipment 1100, and the network equipment 1100 can execute the steps included in the methods of the aforementioned embodiments. The embodiment only simply describes the structure of the network equipment 1100, the specific implementation of which can be obtained by referring to the description in the aforementioned embodiments. As shown in FIG. 11, the network equipment is a second network equipment, and the network equipment comprises a first interface 1101, a second interface 1102, a receiving module 1103, a processing module 1104 and a sending module 1105.

Wherein the second interface 1102 is an air interface;

the receiving module 1103 is used for receiving user data sent by a first network equipment through the first interface 1101 and receiving control signaling sent by the first network equipment through the second interface 1102;

the processing module 1104 is used for sending the user data received by the receiving module 1103 to the sending module 1105 according to the control signaling received by the receiving module 1103; and

the sending module 1105 is used for sending the user data to user equipment.

The network equipment 1100 of the embodiment can execute the steps included in the embodiments of the aforementioned methods. Thus, by referring to the description of the embodiments of the aforementioned methods, the technical effects of the network equipment 1100 can be obtained, which are not described herein.

Further, the sending module 1105 is used for sending the user data to the user equipment through the second interface 1102.

The receiving module 1103 is used for receiving the user data sent by the second network equipment at the (n−M)th transmission time interval (TTI) and receiving the control signaling at the nth TTI, wherein M is a positive integer more than or equal to 1, and n is an integer.

The first interface is an X2 interface, and M is more than 10.

Further, the receiving module 1103 is further used for receiving interval information of a first time period and a second time period sent by the first network equipment before receiving the control signaling sent by the first network equipment; and the processing module 1104 is used for determining the second time period according to the interval information received by the receiving module 1103 and the first time period, and sending the user data to the user equipment according to the control signaling at the second time period, wherein the first time period is the one when the second network equipment receives the control signaling; or

the receiving module 1103 is further used for receiving information of the second time period sent by the first network equipment, before receiving the control signaling sent by the first network equipment; and the processing module 1104 is used for determining the second time period according to the information of the second time period received by the receiving module 1103 and instructing the sending module 1105 to send the user data according to the control signaling at the second time period, wherein the first time period is the one when the second network equipment receives the control signaling.

Further, the processing module 1104 is further used for instructing the sending module 1105 to send capability confirming information before the receiving module 1103 receives the user data, wherein the capability confirming information is used for indicating that the second network equipment supports receiving the control signaling from the second interface 1102;

the sending module 1105 is further used for sending the capability confirming information to the first network equipment according to the instruction of the processing module 1104.

Further, the receiving module 1103 is further used for receiving reference signal (RS) sent from the first network equipment to the second network equipment before receiving the user data sent by the first network equipment through the first interface 1101; the processing module 1104 is further used for determining channel quality between the first network equipment and the second network equipment according to the RS; and the sending module 1105 is further used for informing the first network equipment of the channel quality; or

the processing module 1104 is further used for instructing the sending module 1105 to send the RS before the user data is received; and the sending module 1105 is further used for sending the RS to the second network equipment, so that the first network equipment determines channel quality between the first network equipment and the second network equipment according to the RS.

Further, the receiving module 1103 is further used for receiving user equipment information sent by the first network equipment through the first interface 1101 or the second interface 1102 before receiving the control signaling;

the receiving module 1103 is used for receiving the control signaling in the following mode: detecting and receiving the control signaling according to the user equipment information.

Further, the receiving module 1103 is further used for receiving a transmission time interval (TTI) set determined by the first network equipment before receiving the control signaling;

the receiving module 1103 is used for receiving the control signaling in the following mode: detecting and receiving the control signaling at a TTI included in the TTI set.

Further, the processing module 1104 instructs the sending module 1105 to send the user data in the following mode:

if processing indicating information indicates that the user data acquired from the first network equipment is sent according to the control signaling, instructs the sending module 1105 to send the user data according to the control signaling, wherein the control signaling comprises the processing indicating information for indicating that the user data acquired from the first network equipment is sent to the user equipment according to the control signaling.

Further, the network equipment can further comprise:

a storing module 1106, used for storing the user data sent by the first network equipment and received by the receiving module through the first interface;

the processing module 1104, used for determining the user data corresponding to user equipment information from the storing module 1106 according to the user equipment information in the control signaling after the control signaling is received, and sending the user data corresponding to the user equipment information according to the control signaling.

The first network equipment is one of a base station (BS), an access point (AP), a remote radio equipment (RRE), a remote radio head (RRH), a remote radio unit (RRU) and a relay node;

the second network equipment is one of a base station (BS), an access point (AP), a remote radio equipment (RRE), a remote radio head (RRH), a remote radio unit (RRU) and a relay node.

Another embodiment of the present disclosure provides a network equipment 1200, and the network equipment 1200 can execute the steps included in the methods of the aforementioned embodiments. The embodiment only simply describes the structure of the network equipment 1200, the specific implementation of which can be obtained by referring to the description in the aforementioned embodiments. As shown in FIG. 12, the network equipment is a first network equipment, and the network equipment comprises a first interface 1201, a second interface 1202, a processing module 1203 and a sending module 1204.

Wherein the second interface 1202 is an air interface;

the processing module 1203 is used for instructing the sending module 1204 to send user data of a user equipment to a second network equipment through the first interface 1201, and instructing the sending module 1204 to send control signaling through the second interface 1202;

the sending module 1204 is used for sending the user data of the user equipment to the second network equipment through the first interface 1201, and sending the control signaling through the second interface 1202, so that the second network equipment sends the user data to the user equipment according to the control signaling, wherein the second interface 1202 is the air interface.

The network equipment 1200 provided in the embodiment can execute the steps included in the embodiment of the aforementioned method. Thus, by referring to the description of the embodiments of the aforementioned methods, the technical effects of the network equipment 1200 can be obtained, which are not described herein.

Further, the sending module 1204 is used for sending the user data to the second network equipment at the (n−M)th transmission time interval (TTI), and sending the control signaling at the nth TTI, wherein M is a positive integer more than or equal to 1, and n is an integer.

The first interface 1201 is an X2 interface, and M is more than 10.

Further, before sending the control signaling through the second interface 1202, the sending module 1204 is further used for sending interval information of a first time period and a second time period to the user equipment, and sending the interval information of the first time period and the second time period to the second network equipment; or

before sending the control signaling through the second interface, the sending module 1204 is further used for sending information of a second time period to the user equipment, and sending the information of the second time period to the second network equipment;

wherein, the first time period is the one when the first network equipment sends the control signaling, and the second time period is the one when the second network equipment sends the user data.

Moreover, the network equipment can further comprise:

a receiving module 1205, used for receiving capability confirming information sent from the second network equipment to the first network equipment, wherein the capability confirming information is used for indicating that the second network equipment supports receiving the control signaling from the second interface 1202.

Further, the processing module 1203 is used for judging whether channel quality between the first network equipment and the second network equipment can satisfy the condition that the second network equipment accurately receives the control signaling according to the channel quality; and instructing the sending module 1204 to send the user data of the user equipment to the second network equipment through the first interface 1201, if the first network equipment determines that the channel quality can satisfy the condition that the second network equipment accurately receives the control signaling.

Further, the processing module 1203 is used for instructing the sending module 1204 to send reference signal (RS) to the second network equipment, acquiring the channel quality between the first network equipment and the second network equipment transmitted by the receiving module 1205, and instructing the sending module 1204 to send the user data to the second network equipment through the first interface 1201 if the channel quality can satisfy the condition that the second network equipment accurately receives the control signaling; the sending module 1204 is further used for sending the RS to the second network equipment according to the instruction of the processing module 1203; and the receiving module 1205 is further used for receiving the channel quality informed by the second network equipment, wherein the channel quality is determined by the second network equipment by measuring the RS; or

the receiving module 1205 is further used for receiving RS sent from the second network equipment to the first network equipment; and the processing module 1203 is used for determining the channel quality between the first network equipment and the second network equipment according to the RS, and instruction the sending module 1204 to send the user data of the user equipment to the second network equipment through the first interface 1201 if the channel quality can satisfy the condition that the second network equipment accurately receives the control signaling.

Further, the sending module 1204 is further used for sending user equipment information to the second network equipment before sending the control signaling through the second interface 1202, so that the second network equipment detects the control signaling according to the user equipment information.

Further, the sending module 1204 is further used for sending mode configuration signaling to the user equipment before sending the control signaling through the second interface 1202, wherein the mode configuration signaling is used for indicating that the control signaling and the user data are received at the first time period and the second time period; or,

the sending module 1204 is further used for sending the control signaling comprising the mode configuration signaling through the second interface 1202, wherein the mode configuration signaling is used for indicating that the control signaling and the user data are received at the first time period and the second time period,

wherein, the first time period is the one when the user equipment and the second network equipment receive the control signaling, and the second time period is the one when the user equipment receives the user data from the second network equipment.

Further, the sending module 1204 is used for sending the control signaling comprising processing indicating information through the second interface 1202, wherein the processing indicating information is used for indicating that the user data acquired from the first network equipment is sent to the user equipment according to the control signaling.

Further, before instructing the sending module 1204 to send the control signaling through the second interface 1202, the processing module 1203 is used for determining a transmission time interval (TTI) set, and instructing the sending module 1204 to send information of the TTI set;

the sending module 1204 is further used for sending the information of the TTI set, so that the second network equipment and the user equipment receive the control signaling at a TTI included in the TTI set.

Further, the sending module 1204 is used for sending the information of the TTI set in the following mode: sending the information of the TTI set in a bitmap mode.

Further, the sending module 1204 is used for sending the information of the TTI set in the following mode: sending the information of the TTI set through the second interface 1202.

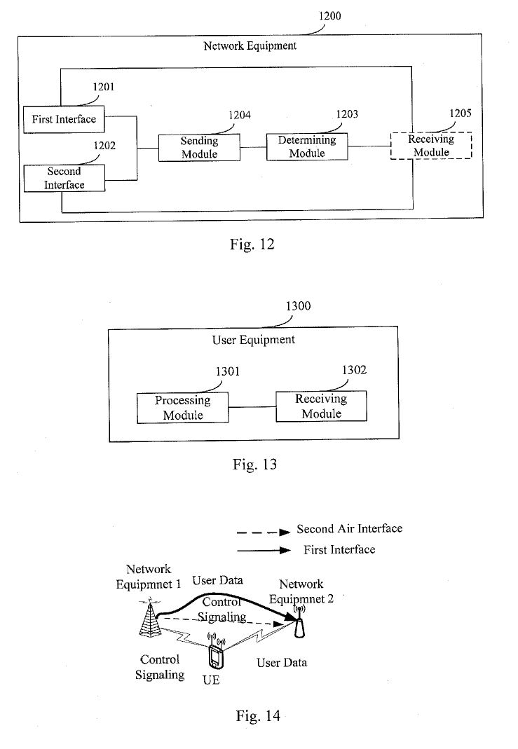

Another embodiment of the present disclosure provides a user equipment 1300, and the user equipment 1300 can execute the steps included in the methods of the aforementioned embodiments. The embodiment only simply describes the structure of the user equipment 1300, the specific implementation of which can be obtained by referring to the description in the aforementioned embodiments. As shown in FIG. 13, the user equipment 1300 comprises a processing module 1301 and a receiving module 1302.

The processing module 1301 is used for controlling the receiving module 1302 to receive control signaling at a first time period and controlling the receiving module 1302 to receive user data at a second time period; and

the receiving module 1302 is used for receiving the control signaling sent by a first network equipment at the first time period and receiving the user data sent by a second network equipment according to the control signaling at the second time period according to the control signaling, wherein the first time period and the second time period are discontinuous.

The user equipment 1300 provided in the embodiment can execute the steps included in the embodiments of the aforementioned methods. Thus, by referring to the description of the embodiments of the aforementioned methods, the technical effects of the user equipment 1300 can be obtained, which are not described herein.

Further, the processing module 1301 is used for controlling the receiving module 1302 to receive the control signaling at the first time period and controlling the receiving module 1302 to receive the user data at the second time period, wherein the first time period and the second time period are in the same transmission time interval (TTI), the first time period and the second time period are spaced by N_sym symbols, and N_sym is more than or equal to 1 and less than or equal to 12; or

the processing module 1301 is used for controlling the receiving module 1302 to receive the control signaling at the first time period and controlling the receiving module 1302 to receive the user data at the second time period, wherein the first time period and the second time period are in different transmission time intervals (TTI).

Further, the processing module 1301 is used for controlling the receiving module 1302 to receive the control signaling in a control domain of a first TTI which the first time period is in, and controlling the receiving module 1302 to receive the user data in a data domain of a second TTI which the second time period is in.

Further, the receiving module 1302 is further used for receiving interval information of the first time period and the second time period sent by the first network equipment before receiving the control signaling sent by the first network equipment;

the processing module 1301 is used for determining the first time period and the second time period according to the interval information and the first time period.

Or, before receiving the control signaling sent by the first network equipment, the receiving module 1302 is further used for receiving information of the second time period sent by the first network equipment, and transmitting the information of the second time period to the processing module; and the processing module is used for determining the second time period according to the information of the second time period.

Further, the receiving module 1302 is further used for receiving mode configuration signaling sent from the first network equipment to the user equipment before receiving the control signaling sent by the first network equipment; and the processing module 1301 is further used for controlling the receiving module 1302 to receive the control signaling at the first time period and receive the user data at the second time period according to the mode configuration signaling received by the receiving module 1302; or,

the processing module 1301 is further used for controlling the receiving module 1302 to receive the control signaling at the first time period and receive the user data at the second time period according to mode configuration signaling comprised in the control signaling.

Moreover, the embodiment of the present disclosure further provides a data transmitting system, comprising the network equipment 1100, the network equipment 1200 and the user equipment 1300 in the aforementioned embodiments, the specific implementations of which can be obtained by referring to the description in the aforementioned embodiments and are not described herein.

The embodiment of the present disclosure can be applied to a network equipment or a user equipment in various communication systems. The user equipment and the network equipment provided in the aforementioned embodiments can further comprise components such as a power controller, a decoding processor and the like. The processing module in the embodiment of the present disclosure can further be named as CPU. Memories can comprise a read-only memory or a random access memory, for providing instructions and data for the processing module. A part of the memories can further comprise a non-volatile random access memory (NVRAM). In a specific application, the user equipment and the network equipment provided in the embodiment of the present disclosure can comprise carriers for accommodating a sending circuit and a receiving circuit, to allow data sending and receiving between the user equipment or the network equipment and a remote position. The sending module and the receiving module can be coupled to an antenna. All the components are coupled together through a bus system, wherein the bus system comprises a power bus, a control bus and a state signal bus besides a data bus.

The aforementioned processor disclosed in the embodiment of the present disclosure is probably an integrated circuit chip, and has signal processing capability. The aforementioned processor can be a general processor, a digital signal processor (DSP), an application-specific integrated circuit (ASIC), a field-programmable gate array (FPGA) or other programmable logic devices, a discrete gate or transistor logic device or a discrete hardware component, and can realize or implement the methods, steps and logic diagrams disclosed in the embodiments of the present disclosure. The general processor can be a microprocessor or any conventional processor such as a baseband processor and the like. The steps of the methods disclosed in the embodiments of the present disclosure can be directly completed by a hardware decoding processor or a combination of hardware and software modules in the decoding processor. The software module can be positioned in a mature storage medium of the field such as a random access memory, a flash memory, a read-only memory, a programmable read-only memory, an electrically erasable programmable read-only memory, a register or the like. The storage medium is positioned in a memory, and a processing module is used for reading information in the memory and completing the steps included in the aforementioned methods in combination with hardware thereof.

Moreover, the present disclosure further provides an application example, in which a network equipment 1 and a network equipment 2 serve a UE, as shown in FIG. 14.

The network equipment 1 is used for determining a scheduling scheme for the UE, sending user data to the network equipment 2 through a first interface and sending control signaling to the network equipment 2 through a second interface;

the network equipment 2 is used for receiving and acquiring the control signaling, processing the user data acquired from the network equipment 1 according to the control signaling, and sending generated data signals; for example, in an LTE system, a physical resource block (PRB) is the minimum unit for scheduling a downlink frequency resource, and one PRB comprises 12 subcarriers on a frequency domain. If the control signaling indicates that the 1st to 3rd PRBs are distributed to the UE to send downlink signals, the network equipment 2 maps the user data to the 1st to 3rd PRBs after receiving the control signaling, and sends the user data to the UE;

the UE detects the control signaling sent by the network equipment 1 at a first time period through the second interface, and receives the data signals sent by the network equipment 2 at the second time period according to the control signaling, wherein the first time period and the second time period are discontinuous. For example, the control signaling indicates that the 1st to 3rd PRBs are distributed to the UE to send the downlink signals, and the UE receives the data signals on the 1st to 3rd PRBs.

The network equipment 1 sends the control signaling at the first time period, the network equipment 2 sends the data signals to the UE at the second time period, and the first time period and the second time period are discontinuous, the advantage of which is that, after a certain period of time from receiving the control signaling sent by the network equipment 1 at the first time period, the network equipment 2 can detect and acquire the control signaling sent by the network equipment 1, and schedule the user data according to the control signaling. In this way, the network equipment 2 finally can send the data signals to the UE at the second time period. A period of time is reserved for the network equipment 2 between the first time period and the second time period, so that the processing speed requirements of the network equipment 2 for detecting and acquiring the control signaling and scheduling the user data are reduced.

Because the transmission of the signals has certain delay, the first time period and the second time period are not understood to be absolute time windows for the network equipment 1, the network equipment 2 and the UE. For example, when the network equipment 1 starts sending the control signaling, the network equipment 2 can receive the control signaling after certain delay, and therefore, the first time period understood by the network equipment 1 and the network equipment 2 has certain deviation on the absolute time. However, in the embodiment of the present disclosure, the control signaling is sent through the air interface, and the second network equipment sends the data to the UE through the air interface, so that the delay is very short, and the deviation can be ignored.

By adopting the methods provided in the embodiments of the present disclosure, the control signaling can be sent through the air interface, so that the transmission delay of the control signaling between the network equipments is shortened; and the user data is sent through the first interface, so that excessive information is prevented from being sent through the air interface, and the complexity of acquiring the user data by the network equipment is reduced.

It can be understood by those of ordinary skill in the art that all of or a part of steps in the methods of the aforementioned embodiments can be completed by instructing related hardware through programs, the programs can be stored in a computer-readable storage medium, and the storage medium can comprise a read only memory (ROM), a random access memory (RAM), a disk, an optical disk or the like.

The methods, user equipments and base stations provided in the embodiments of the present disclosure are introduced above in details. The principles and implementations of the present disclosure are illustrated by using specific examples in the present disclosure, and the illustration of the aforementioned embodiments is only used for assisting in understanding the methods of the present disclosure and core concepts thereof. Meanwhile, for those of ordinary skill in the art, modification can be made to the specific implementations and application scope in accordance with the concept of the present disclosure. In conclusion, the contents of the specification should not be understood as limitation to the present disclosure.

What is claimed is:

1. A method for sending data, comprising:
receiving, by a second network equipment, user data sent by a first network equipment through a first interface;
receiving, by the second network equipment, control signaling sent by the first network equipment through a second interface, wherein the second interface is an air interface; and
sending, by the second network equipment, the user data to a user equipment according to the control signaling.

2. The method according to claim 1, wherein the sending, by the second network equipment the user data to the user equipment, comprises:
sending, by the second network equipment, the user data to the user equipment through the second interface.

3. The method according to claim 1, wherein:
the receiving, by the second network equipment, the user data sent by the first network equipment, comprises receiving, by the second network equipment, the user data sent by the first network equipment at the (n−M)^{th} transmission time interval (TTI), wherein M is a positive integer greater than or equal to 1, and n is an integer; and
the receiving, by the second network equipment, the control signaling sent by the first network equipment, comprises receiving, by the second network equipment, the control signaling at the n^{th} TTI.

4. The method according to claim 3, wherein the first interface is an X2 interface, and M is more than 10.

5. The method according to claim 1, wherein before the receiving, by the second network equipment, the control signaling sent by the first network equipment, the method further comprises:
receiving interval information of a first time period and a second time period sent by the first network equipment; the receiving, by the second network equipment, the control signaling comprises receiving, by the second network equipment, the control signaling sent by the first network equipment through the second interface at the first time period; the sending, by the second network equipment, the user data to the user equipment comprises determining the second time period according to the interval information and the first time period; and sending the user data to the user equipment according to the control signaling at the second time period; or,
receiving information of a second time period sent by the first network equipment; the receiving, by the second network equipment, the control signaling comprises receiving, by the second network equipment, the control signaling sent by the first network equipment through the second interface at the first time period; the sending, by the second network equipment, the user data to the user equipment comprises determining the second time period according to the information of the second time period; and sending the user data to the user equipment according to the control signaling at the second time period.

6. The method according to claim 1, wherein the sending, by the second network equipment, the user data to the user equipment according to the control signaling, comprises:
after the receiving, by the second network equipment, the control signaling, determining the user data corresponding to user equipment information according to the user equipment information in the control signaling;
scheduling the user data corresponding to the user equipment information acquired from the first network equipment according to the control signaling;
generating data signals by using the user data corresponding to the user equipment information; and
sending the data signals to the user equipment.

7. A network equipment, comprising:
a first interface;
a second interface, wherein the second interface is an air interface;
a receiving module, configured to receive user data sent by a first network equipment through the first interface and receive control signaling sent by the first network equipment through the second interface;
a processing module, configured to instruct a sending module to send the user data received by the receiving module according to the control signaling received by the receiving module; and
the sending module, configured to send the user data to a user equipment,
wherein the network equipment comprises a second network equipment.

8. The network equipment according to claim 7, wherein the sending module is configured to send the user data to the user equipment through the second interface.

9. The network equipment according to claim 7, wherein the receiving module is configured to receive the user data sent by the second network equipment at the (n−M)^{th} transmission time interval (TTI) and receive the control signaling at the n^{th} TTI, wherein M is a positive integer greater than or equal to 1, and n is an integer.

10. The network equipment according to claim 9, wherein the first interface is an X2 interface, and M is more than 10.

11. The network equipment according to claim 7, wherein:
the receiving module is further configured to receive interval information of a first time period and a second time period sent by the first network equipment, before receiving the control signaling sent by the first network equipment; and the processing module is configured to determine the second time period according to the interval information received by the receiving module and the first time period, and send the user data to the user equipment according to the control signaling at the second time period, wherein the first time period is the one when the second network equipment receives the control signaling; or
the receiving module is further configured to receive information of the second time period sent by the first network equipment, before receiving the control signaling sent by the first network equipment; and the processing module is configured to determine the second time period according to the information of the second time period received by the receiving module, and instruct the sending module to send the user data according to the control signaling at the second time period, wherein the first time period is the one when the second network equipment receives the control signaling.

12. The network equipment according to claim 7, wherein:
the processing module is further configured to instruct the sending module to send capability confirming information before the receiving module receives the user data, wherein the capability confirming information is used for indicating that the second network equipment supports receiving the control signaling from the second interface; and
the sending module is further configured to send the capability confirming information to the first network equipment according to the instruction of the processing module.

13. The network equipment according to claim 7, wherein:
the receiving module is further configured to receive a reference signal (RS) sent from the first network equipment to the second network equipment before receiving the user data sent by the first network equipment through the first interface; the processing module is further configured to determine channel quality between the first network equipment and the second network equipment according to the RS; and the sending module is further configured to inform the first network equipment of the channel quality; or
the processing module is further configured to instruct the sending module to send a RS before the user data is received; and the sending module is further configured to send the RS to the second network equipment, so that the first network equipment determines channel quality between the first network equipment and the second network equipment according to the RS.

14. The network equipment according to claim 7, wherein:
the receiving module is further configured to receive user equipment information sent by the first network equipment before receiving the control signaling; and
the receiving module is configured to receive the control signaling in the following mode: detecting and receiving the control signaling according to the user equipment information.

15. The network equipment according to claim 7, wherein:
the receiving module is further configured to receive a transmission time interval (TTI) set determined by the first network equipment before receiving the control signaling; and
the receiving module is configured to receive the control signaling in the following mode: detecting and receiving the control signaling at a TTI included in the TTI set.

16. A user equipment, comprising:
a processing module, configured to control a receiving module to receive control signaling at a first time period and control the receiving module to receive user data at a second time period; and
the receiving module, configured to receive the control signaling sent by a first network equipment at the first time period and receive the user data sent by a second network equipment according to the control signaling at the second time period according to the control signaling, wherein the first time period and the second time period are discontinuous.

17. The user equipment according to claim 16, wherein:
the processing module is configured to control the receiving module to receive the control signaling at the first time period and control the receiving module to receive the user data at the second time period, wherein the first time period and the second time period are in the same transmission time interval (TTI), the first time period and the second time period are spaced by N_sym symbols, and N_sym is greater than or equal to 1 and less than or equal to 12; or
the processing module is configured to control the receiving module to receive the control signaling at the first time period and control the receiving module to receive the user data at the second time period, wherein the first time period and the second time period are in different transmission time intervals (TTI).

18. The user equipment according to claim 17, wherein the processing module is configured to:
control the receiving module to receive the control signaling in a control domain of a first TTI, wherein the first time period is in the first TTI; and
control the receiving module to receive the user data in a data domain of a second TTI, wherein the second time period is in the second TTI.

19. The user equipment according to claim 16, wherein:
the receiving module is further configured to receive interval information of the first time period and the second time period sent by the first network equipment before receiving the control signaling sent by the first network equipment; and the processing module is configured to determine the first time period and the second time period according to the interval information and the first time period; or,
the receiving module is further configured to receive information of the second time period sent by the first network equipment before receiving the control signaling sent by the first network equipment; and the processing module is configured to determine the second time period according to the information of the second time period received by the receiving module.

20. The user equipment according to claim 16, wherein:
the receiving module is further configured to receive mode configuration signaling sent from the first network equipment to the user equipment before receiving the control signaling sent by the first network equipment; and the processing module is further configured to control the receiving module to receive the control signaling at the first time period and receive the user data at the second time period according to the mode configuration signaling received by the receiving module; or,
the processing module is further configured to control the receiving module to receive the control signaling at the first time period and receive the user data at the second time period according to mode configuration signaling comprised in the control signaling.
